(19) United States
(12) Patent Application Publication
(10) Pub. No.: US 2026/0340991 A1
(43) Pub. Date: Oct. 29, 2026

(54) DeepWind: Artificial Intelligence Device and Methods for Recognizing Wind Along a Projectile Trajectory Path using String

(71) Applicants: Kendyl A. Roman, Sunnyvale, CA (US); John Livacich, Los Gatos, CA (US)

(72) Inventors: Kendyl A. Roman, Sunnyvale, CA (US); John Livacich, Los Gatos, CA (US)

(73) Assignee: Evrio, Inc., SANTA CLARA, CA (US)

(21) Appl. No.: 19/686,627

(22) Filed: May 23, 2026

Related U.S. Application Data
(63) Continuation-in-part of application No. 18/635,003, filed on Apr. 15, 2024, now Pat. No. 12,664,672.
Application No. 18/635,003 is a continuation-in-part of application No. 18/431,980, filed on Feb. 4, 2024.

(51) Int. Cl. G06V 10/764; G06T 7/80; G06V 10/82

(52) U.S. Cl. CPC G06V 10/764; G06T 7/80; G06V 10/82

(57) ABSTRACT

Artificial intelligence (AI) systems and methods for recognizing winds effect on a string or powerline. Embodiments include a deep learning models implemented algorithmically, or as deep neural networks, to detect a string and identify wind direction and speed along at least a segment of a projectile trajectory path to a target. The AI models are trained with images (photos and/or video) of strings as well as wind direction and speed at points along the projectile trajectory path. In some embodiments, string intercepts are found algorithmically. In some embodiments, parameters are entered based on known configurations. In other embodiments, the AI device calibrates parameters using AI methods. The trained, portable AI device recognizes crosswind values in real time. When optimum wind speed is sustained for brief time, a green light is illuminated. An aiming point is adjusted for range and crosswind.

### CROSS-REFERENCE TO RELATED APPLICATIONS

This application is a continuation-in-part of co-pending U.S. patent application Ser. No. 19/676,611, filed May 13, 2026, which is a is a continuation-in-part of co-pending U.S. patent application Ser. No. 18/635,003, filed Apr. 15, 2024, which is a continuation-in-part of co-pending U.S. patent application Ser. No. 18/431,980, filed Feb. 4, 2024.

### PRIOR ART

### Firing Device and Projectiles

Firing devices such as bows, crossbows, rifles, pistols, other guns, and artillery have been used for sport, hunting, law enforcement, and military. Each firing device is used to launch a projectile such as an arrow, dart, bullet, ball, or explosive shell along a projectile trajectory.

FIG. 1A shows a user (in this case, an archer) 100 with a bow 102 with a bow sight 110 and an arrow 104. The bow sight 110 comprises pins adjusted e.g., for twenty yards, forty yards, and sixty yards, namely a twenty-yard pin, a forty-yard pin, and a sixty-yard pin, respectively. The user 100 has a rangefinder 6.

FIG. 1B shows a rifle 300 with a rifle scope 302. Rifle balls and/or bullets are typically shot from a gun using the arms to aim and sight by aligning the gun sights or gun scope reticle with the target.

Artillery balls and shells are typically shot by adjusting the aim mechanically.

Arrows, spears, balls, bullets, and shells when fired follow a ballistic trajectory. Such projectiles, which are not self-propelled, move through air according to a generally parabolic curve due primarily to the effects of gravity.

The actual projectile trajectory path is not a perfect parabola in a plane due to many factors, such as air drag and lift, crosswind, head wind, tail wind, spin drift, and Coriolis effect. Each bullet type has a different weight and shape which affects the ballistic trajectory. Ballistic coefficients can be determined of each bullet. Drag is affected by environmental factors such as temperature, humidity, and barometric pressure.

The Army Research Laboratory published Wind Drift of Projectiles: A Ballistics Tutorial, ARL-TR-1124, by Herbert A. Leupold, October 1996.

Let's Code Physics, Projectile Motion 12—Drag and Wind teaches programming models for drag and wind on projectiles. Source code is available at the letscodephysics Google Site (Let's Code Physics/projectile motion/12 3D projectile motion—football field goal—w wind.py).

Rifle and bow scopes conventionally have been fitted with reticles of different forms. Some have horizontal and vertical crosshairs. These reticles are fixed in that the display does not change based on range information. Also, these reticles indicate the approximate hold-over position in that they are positioned under the center of the scope, i.e., below where the crosshairs intersect. They are not necessarily precise, for example, for a specific bow and archer or for a specific rifle and cartridge but are approximation for the general case.

### Smart Devices

Hunters and other firearm and bow users commonly utilize handheld rangefinders (see device 6 in FIG. 1A) to determine ranges to targets. Generally, handheld rangefinders utilize lasers to acquire ranges for display to a user. Utilizing the displayed ranges, the user makes sighting corrections to facilitate accurate shooting. Handheld rangefinders, telescope sights, and other optical devices typically comprise a laser range sensor and an inclinometer.

Our U.S. Pat. No. 9,057,587, issued Jun. 16, 2015, and U.S. Pat. No. 9,068,795, issued Jun. 30, 2015, both included by reference, disclose and claim a smart rangefinders which: a) provide an aiming point; b) provide a digital rangefinder having a video camera and high-resolution digital display; and c) displays an aiming point, corrected for range and wind effect anywhere on the high-resolution display.

These patents also disclose the use of a smart phone, such as an iPhone, as a display for a digital rangefinder.

### Artificial Intelligence Advances

The U.S. Defense Advanced Research Projects Agency (DARPA) funded the Cognitive Assistant that Learns and Organizes (CALO) project for five years from 2003 to 2008. CALO brought together over 300 researchers from 25 of the top university and commercial research institutions. Software and documentation are available on the PAL website: https://pal.sri.com.

Several AI technologies have spun off from the CALO work, including, for example, Apple's Siri speech recognition, analysis, and speech synthesis.

In October 2006, Intel released version 2 of Open Source Computer Vision Library (OpenCV 2). In August 2012, opencv.org began providing support for OpenCV. Applications for OpenCV include object detection and facial recognition systems. Open source code repositories are available on github.com e.g., opencv/opencv.

In 2013, NVIDIA introduced the Tegra 4. With NVIDIA GPU-accelerated deep learning frameworks, researchers and data scientists can significantly speed up deep learning training that could otherwise take days and weeks to just hours and days. When models are ready for deployment, developers can rely on GPU-accelerated inference platforms for the cloud, embedded device, or self-driving cars, to deliver high-performance, low-latency inference for the most computationally-intensive deep neural networks. https://www.nvidia.com/en-us/glossary/deep-learning/.

In June 2014, Facebook AI Research in Menlo Park, CA, published DeepFace: Closing the Gap to Human-Level Performance in Face Verification. DeepFace discloses the use of a four-stage pipeline, comprising: detect, align, represent, and classify. In its deep learning model, the representation stage uses a nine-layer deep neural network. The paper discloses an architecture comprising a front-end of a single convolution-pooling-convolution filtering on the rectified input, followed by three locally-connected layers and two fully-connected layers.

Images are aligned by detecting 6 initial fiducial points inside the detection crop (bounding rectangle) centered at the center of the eyes, tip of the nose and mouth locations. The detected face is scaled, rotated, and translated. Additional fiducial points are identified in the 2D-aligned crop. The image is 3D aligned by transforming Delaunay triangulation derived from the 67 fiducial points. The 3D-aligned image is given to the first layer of a large deep neural network.

As explained by Sefik Ilkin Serengil, the DeepFace deep learning model is a layered convolutional neural network. Each layer is named with a letter and number. The number refers to the index from 1 to 8 and letter states the type of layer. C refers to convolutional layer, M refers to max pooling, L refers to locally connected layer and F refers to fully connected layer. https://sefiks.com/2020/02/17/face-recognition-with-facebook-deepface-in-keras
OpenFace is open source code. https://github.com/cmusatyalab/openface
OpenFace includes the FaceBook neural network source code. https://github.com/facebookarchive/fbnn

In December 2014, Baidu Research's Silicon Valley AI Lab, published Deep Speech: Scaling up end-to-end speech recognition. Deep Speech trained a large recurrent neural network (RNN) using multiple GPUs and thousands of hours of data. The structure of the RNN model is disclosed in the paper.

Cornell University's Cornell Lab of Ornithology, Merlin project was funded by the Natural Science Foundation. Photo ID, released Nov. 30, 2017, uses computer vision technology, developed as part of Dr. Grant Van Horn's doctoral work at Caltech, to identify birds in photos. Sound ID, released Jun. 23, 2021, learned to recognize the vocalizations of different bird species. Sound ID was trained on audio recordings that are first converted to visual representations (spectrograms), then analyzed using computer vision tools similar to those of Photo ID. Both Photo ID and Sound ID run on smart phones, such as the Apple iPhone. https://merlin.allaboutbirds.org

Grant Van Horn's PhD thesis is entitled Towards a Visipedia: Combining Computer Vision and Communities of Experts, and details recent advances in the use of deep convolutional neural networks in image analysis.

U.S. Pat. No. 11,140,312 was filed by Swarovski-Optik Jul. 17, 2020 (Swarovski '312). U.S. Patent Application 2023/0283882 published Sep. 7, 2023 (Swarovski '882). Both disclose a smart binocular.

FIG. 2 shows monocular 410 comprising a housing 20 supporting an eyepiece 22, a lens 24, an input, an operating button, 32. The components inside the housing 20 comprise: computing element 16, memory 18, wireless communications 19, image sensor (digital camera) 25, audio sensor 29. Swarovski claims require several other elements. Swarovski discloses using the wireless communications 19 to communicate with a smart phone, such as an iPhone 11 (not shown) having a high-resolution, touch screen display 31 (not shown). While Swarovski '312 suggests that the smart phone 11 separately execute a mobile app which can recognize an image of a bird, it does not disclose a deep learning model running on the computing element 16 of the monocular 410. The type of bird is recognized by means of a remote image database and an image recognition algorithm. Further, Swarovski '312 discloses using the operating button 32 to start the image capture for object recognition, object detection, and object classification to be executed on the smart phone 11.

In 2019, Stanford University researchers published a paper, DeepWind: Weakly Supervised Localization of Wind Turbines in Satellite Imagery (DeepWind Wind Turbines) uses image recognition to map global wind energy infrastructure using satellite images and discloses weakly supervised convolutional neural networks to detect the presence and locations of wind turbines.

Chinese government funded researchers at College of Computer Science and Technology, Ocean University of China and School of Computing and Artificial Intelligence, Southwest Jiaotong University, issued a paper, available online on Jan. 20, 2024, DeepWind: a heterogeneous spatio-temporal model for wind forecasting. DeepWind for Numerical Weather Prediction (NWP) Correction discloses a deep learning heterogeneous network, which learns spatio-temporal representations, and which can simultaneously correct the NWP of diverse wind variables across multiple weather stations. Source code is released at https://github.com/Rittersss/DeepWind.

In January 2024, Swarovski Optik announced smart binoculars, namely, AX Visio 10×32 binoculars, comprising a neural processing unit (NPU) for object recognition processing, which identifies over 9,000 species of birds and mammals using Merlin Photo ID and Sound ID image recognition technology.

In January 2024, Apple unveiled chips having capabilities to run generative AI, for example, supporting billions of data parameters. The S9 chip allows Siri to access and log data without connecting to the Internet. The A17 Pro chip in the iPhone 15 comprises a neural engine which is twice as fast as previous generations. These advances will allow AI models to run directly on iPhones.

Machine learning and object detection can be implemented in different ways. For example, there are algorithmic object detectors, e.g., using Viola-Jones, HOG, SVM, SSD approaches, and there are deep learning object detectors, e.g., using Deep Neural Networks (DNN) including Convolutional Neural Networks (CNN) such as DeepFace, Dlib (Max Margin Object Detection) and YOLO.

Thus, the machine learning models for recognizing and characterizing audio and images, as well as source code for implementing them, GPU systems for learning, and handheld devices for operating those machine learning models are well known in the art.

### Windage and Elevation

For hundreds of years, hunters and soldiers have learned the mantra “Windage and Elevation.”

Our patented Flight Path® technology (disclosed, for example, in U.S. Pat. No. 9,057,587 referenced above) currently available in Leupold RX-FullDraw 5 and RX-1400i True Ballistic Range/Wind (TBR/W) Gen 2, does an excellent job of handling elevation by providing an aiming point corrected for shoot angle, distance, and ballistics along a vertical plane including the line of sight to a desired target.

However, there has been a long felt need to be able to accurately recognize the winds impact on a projectile and to quickly and dynamically make adjustments despite constant changing, difficult to interpret changes in the wind. Wind adjustment has been largely guesswork.

Until now accurate wind recognition has been the “Holy Grail” sought after by the industry.

What is needed is a device and methods for recognizing wind along a projectile trajectory path so that a user can accurately aim and hit a desired target regardless of the wind speed and direction at different points along the path. Further, what is needed is an indication that wind currently is in a likely sustained favorable state for a brief period of time, such that a user has time to aim and fire.

Recent wildfires causing human deaths and extensive damage have been attributed to high power electricity power distribution lines. For example, for the North Bay Fires (including the Tubbs Fire) in 2017 and the Camp Fire 2018 Pacific Gas and Electric (PG&E) recently paid $13.5 billion to fire victims, $1 billion to public entities, and $11 billion to insurance companies. In response to these damaging fires, power distribution companies have increased their monitoring of power lines, have undergrounded certain power lines, and have started shutting off power during forecast high wind events.

What is needed are systems and methods for recognizing wind effects in real time along segments of power lines so that power distribution companies can avoid causing wildfires and so that, with more accurate real time information regarding cross wind effects on a power cables, power distribution companies can accurately shut off power to avoid fires and can minimize power shut off periods.

### SUMMARY OF THE INVENTION

The present invention solves the above-described problems and provides a distinct advance in the art of AI devices recognizing wind along a projectile trajectory path to a target object. The present invention provides devices and methods for recognizing wind along a projectile trajectory path so that a user can accurately aim and hit a desired target regardless of the wind speed and direction at different points along the path. Further, an indication that wind currently is in a likely sustained favorable state for a brief period of time, such that a user has time to aim and fire. More particularly, the invention provides an AI device with an image sensor and/or audio sensor and a machine learning model wherein the sensor(s) and machine learning model are configured to recognize the reaction of an object, such as a string, to wind along the projectile trajectory path, and wherein the AI device outputs wind information regarding the projectile trajectory. The string is the teacher. Such information facilitates accurate, effective, and safe firing device use by providing an aiming point. Further the present invention provides systems and means for determining the wind effects on a segment of a powerline during high wind events.

Machine learning models may be algorithmic or deep neural networks. Different object detectors, shape predictors, and classifiers may be implemented with different machine learning models. Some models may require less computing power and neural processors, allowing for devices that are battery operated, and which provide real time distance displays.

The AI device further comprises a computing element, a memory, and a display. The machine learning model operates on the computing element and memory and provides output to the display.

In one embodiment, the AI device further comprises wireless communication to communicate wirelessly with remote sensors, such as wind meters (also known as anemometers) or with a handheld rangefinder, smart scope, smart binocular, or other device.

The deep learning model comprises a deep neural network.

In some embodiments, the deep neural network is a convolutional neural network.

During training, inputs to the deep learning model comprise wind speed and direction at a predetermined number of points along the projectile trajectory path, and data regarding the string, such as a still or video image and/or an audio recording.

In one embodiment, the sensor is an audio sensor.

In one embodiment, the sensor is an image sensor.

In one embodiment, both an image sensor and an audio sensor provide data regarding the current state effect of wind on the string.

In one embodiment, the AI device outputs wind speed and direction.

In one embodiment, the AI device outputs crosswind effect.

In one embodiment, the AI device outputs headwind or tailwind effect.

In one method embodiment to recognize wind along the projectile trajectory path to the target, steps comprise:
a) training the machine learning model,
b) placing the string on a plurality of support rods positioned along a segment of the projectile trajectory path,
c) placing AI device at the start of the projectile trajectory path where it can sense the string,
d) enabling sensing,
e) receiving outputs regarding the recognized wind speed and direction along the projectile trajectory path.

In one method embodiment to recognize wind along the projectile trajectory path to the target, steps further comprise displaying the crosswind speed on the display.

In one method embodiment to recognize wind along the projectile trajectory path to the target, steps further comprise displaying headwind or tailwind speed on the display.

In one embodiment, the AI device further comprises a rangefinder comprising crosshairs for positioning the rangefinder to range the target, an inclinometer for sensing the angle to the target, and a range sensor for determining the line-of-sight range to the target.

In one embodiment, the AI device display comprises a shoot-for range indicator,

In one embodiment, the AI device display indicates a shoot-for range adjusted for shooting angle and headwind or tailwind.

In one embodiment, the AI device is embedded in a handheld rangefinder.

In one embodiment, the AI device is embedded in a rifle scope.

In one embodiment, the AI device is embedded in a binocular.

In one embodiment, the AI device is embedded in a smart phone.

In one embodiment, the AI device is embedded in an iPhone.

In one embodiment, the AI device is embedded in a smart tablet.

In one embodiment, the AI device illuminates an aiming point adjusted for crosswind.

In one embodiment, the AI device determines an optimum wind speed which is sustained for a repeatable period of time and illuminates a green light when that optimum wind speed is present.

In another embodiment, the AI device determines an optimum wind speed which is sustained for a repeatable period of time and illuminates a yellow light when that optimum wind speed is approaching.

In yet another embodiment, the AI device determines that the wind is unstable or extreme and illuminates a red light.

In one system embodiment, a string is attached through a pulley to the top of a rod and the flex of the rod is an additional input to the machine learning model.

Further, in one system embodiment, the machine learning model detects the location of the rod in the image and recognizes the flex of the rod.

In some system embodiments, multiple strings are placed along different segments of the projectile trajectory path.

In other embodiments, the AI device detects a plurality of objects along the projectile trajectory path, such as grass, trees, or dust and recognizes wind information based on those objects in nature.

In other embodiments, the AI device observes a projectile's flight along the projectile trajectory path and determines the wind impact on the projectile.

In other embodiments, the AI device detects a plurality of strings, wind socks, weather vanes, or other objects along an airport runway recognizes wind information based on those objects at an airport.

In other embodiments, the AI device observes a projectile's impact relative to the target and determines an adjusted aiming point.

In other embodiments, the string is a tale tell connected to the sail of a sailboat or a wing of a glider or other aircraft and provides information about consistent flow or changes of the air across the sail or wing. In one of these embodiments the AI device provides a warning regarding a change in the air flow, or an imminent stall condition.

In one embodiment, the AI device further comprises wireless communication to communicate wirelessly with remote sensors, such as wind meters (also known as anemometers) or other atmospheric meters.

In some embodiments, the machine learning model comprises a deep neural network.

In some embodiments, the deep neural network is a convolutional neural network.

In some embodiments, a cropped image or a cropped aligned image is an input to the machine learning model.

Some system embodiments for recognizing wind effects on an object from an origin point to a far point comprise: a computing element, a memory connected to the computing element, a machine learning model implemented in the computing element and the memory, a display connected to the computing element, an image sensor, and a lens with a known magnification, in the optical path of the image sensor, wherein the image sensor captures a digital image having the known magnification, wherein the digital image is transferred to the memory and analyzed by the computing element, wherein the computing element recognizes the object in the magnified digital image, wherein the computing element determines a plurality of fiduciary points on the object, wherein the computing element determines the wind effects on the object, and wherein a crosswind valve of the wind effects is shown on the display.

In some such system embodiments, the machine learning model identifies the origin point and the far point and the distance between the origin point and the far point.

In some such system embodiments, the machine learning model comprises an algorithmic model.

In some such system embodiments, the machine learning model comprises a deep neural network, and the crosswind value is a classification output of the deep neural network.

Some such system embodiments comprise wireless communication, where the digital image is transmitted via the wireless communication.

In some such system embodiments the image sensor and the lens are configured in a fixed location, and the computing element, the memory, and the display are configured in a second location, whereby the crosswind valve is displayed at a location remote from the fixed location.

In some embodiments the image sensor and the lens are configured in a drone and the computing element, the memory, and the display are configured in a location separate from the drone.

Some embodiments comprise a battery powered, handheld device comprising an eyepiece connected to a housing for viewing the display, a shroud around the eyepiece, whereby the eyepiece is shielded,

Some embodiments of such handheld devices comprise a crosshair shown in the display, where a target object is selected when an input button is pressed, and the device determines both a range to the target object and the wind effects along the projectile trajectory path to the target object, and displays a range and wind adjust aiming point.

In some embodiments a machine learning model detects a string, or a power cable, forming a parabolic curve and calculates a crosswind value based on deflection angle of the string or the power cable.

In some embodiments the deflection angle is based on fiduciary points output by a shape predictor.

In some embodiments the deflection angle is based on intercepts along radial arcs at predetermined distances between the origin and the far end of the string or power cable.

In some embodiments parameters are entered by the user based on a fixed configuration

In some embodiments parameters are automatically determined by analysis of the image by the AI device.

An exemplary automatic calibration method comprises the steps of: detecting a wind deflected object, determining the pixel coordinates of the origin point and the far point, calculating the distance between the origin point and the far point, calculating a 3D yaw, and calculating the 3D pitch.

A fast, real time intercept finding method of finding the current fiduciary point on the wind deflected object comprises the steps of calculating an angular line in image pixel coordinates, calculating a center point on the angular line in image pixel coordinates and the radius pixel length at a predetermined percentage of the distance from the origin point to the far point, finding an intercept point on a radial arc with the current wind deflected object, determining an angle at the center point between the no wind intercept and the current fiduciary point on the wind deflected object which is the found intercept point, and calculating the crosswind value.

In some embodiments of a fast intercept finding method a intercept is found by matching the color components of an image pixel on the radial arc with expected color components and tolerances.

Some embodiments improve accuracy by ignoring outlier results and averaging remaining results.

Other aspects and advantages of the present invention will be apparent from the following detailed description of the preferred embodiments and the accompanying drawing figures.

### Objects and Advantages

Accordingly, the present invention provides the following objects and advantages:
To provide a display that provides dynamic information regarding a projectile trajectory.
To provide a lightweight rangefinder comprising a high-resolution display and a digital camera, wherein the display provides an aiming point adjusted for wind and distance.
To provide a lightweight rangefinder comprising a high-resolution display and a digital camera, wherein the display provides an aiming point adjusted for wind effect.
To provide lightweight, handheld AI device for recognizing current wind along a projectile trajectory path to a desired target.
To provide an AI device, having a deep learning model, which is trained to recognize the wind effect along a projectile trajectory path.
To provide an AI system for determining wind effect on a section of a power line.

### BRIEF DESCRIPTION OF DRAWINGS

A preferred embodiment of the present invention is described in detail below with reference to the attached drawing figures, wherein:

FIG. 1A illustrates an archer with a bow with a bow sight;

FIG. 1B illustrates a rifle with a scope;

FIG. 2 illustrates a smart monocular with a digital camera image sensor;

FIG. 3 is a block diagram of an AI device;

FIG. 4 illustrates the AI device in a housing and an operating button input;

FIG. 5 illustrates the training of the AI device with a string, supported by a near rod and a far rod, and wind sensors, positioned along a projectile trajectory path to a target;

FIG. 6A illustrates an archer with a bow and the projectile trajectory path of an arrow to a target;

FIG. 6B illustrates a user with a rifle and the projectile trajectory path of a bullet to a target;

FIGS. 7A through 7C illustrate a plurality of strings, each positioned at different segments and heights along a projectile trajectory path to a target;

FIGS. 8A through 8D illustrate a flexible rod and extensions, preferable marked with dark and light bands;

FIGS. 9A and 9B illustrate lockable inserting ends and receiving ends for embodiments of the flexible rod and extensions, and FIG. 9B further illustrates a ground stake for supporting the rod assembly;

FIGS. 10A through 10F illustrate the use and operation of the AI device;

FIG. 10A illustrates the AI device with a string, positioned along a projectile trajectory path to a target;

FIG. 10B illustrates an image captured by the AI device showing string shape and position, visually relative height of the flexible rods supporting the string, and the flex of the rods;

FIG. 10C illustrates a detection crop of the image with four bounding points forming a bounding rectangle containing the cropped image of the string and rods;

FIG. 10D illustrates fiducial points found on the string and rods;

FIG. 10E illustrates fiducial points defining the shape and position of the string;

FIG. 10F illustrates fiducial points defining the flex of the flexible rod;

FIGS. 11A and 11B illustrates a plurality of strings, each positioned at different angles relative to the projectile trajectory path to the target;

FIG. 12 illustrates a display with indication of the crosswind speed relative to the path to the desired target, and indicators of a predicted steady state of optimum wind;

FIG. 13 illustrates crosswind and tailwind vector elements of wind;

FIGS. 14A and 14B illustrate embodiments of display elements with crosswind speed and direction indicators and with headwind/tailwind speed indicator. FIG. 14B includes indicators of a steady state of optimum wind;

FIGS. 15A through 15C illustrate a display with indication of the crosswind speed and direction and headwind/tailwind speed, each relative to the path to the desired target, indicators of a steady state of optimum wind, and an adjusted aiming point, the aiming point adjusted for crosswind and range adjusted for tailwind/headwind;

FIG. 16 shows a high-resolution digital display, such as on an iPhone, providing indication of the crosswind speed and direction and headwind/tailwind speed, indicators of a steady state of optimum wind, and an adjusted aiming point, the aiming point adjusted for crosswind and range adjusted for tailwind/headwind;

FIG. 17 is a rear perspective view of a digital rangefinder device;

FIG. 18 is a front perspective view of the rangefinder device of FIG. 17;

FIG. 19 illustrates a string and flexible rods placed in a harsh, rough environment with hills and valleys and strong winds at different speeds and directions along the projectile trajectory path;

FIG. 20 illustrates a string supported by a rod at the origin and attached to a plate at a far point and the fiduciary points and cross wind speed determined by an AI device;

FIG. 21 illustrates an algorithmic method of determining a string intercept along radial arc at a predetermined distance along a angular line in a captured image;

FIG. 22 illustrates mapping real-world angular measurements to 2D pixel coordinates in an analyzed image;

FIG. 23 illustrates the steps in an AI calibration method;

FIG. 24 illustrates the steps in a string intercept method, executed following the AI calibration method of FIG. 23;

FIG. 25 illustrates the steps in another string intercept method;

FIG. 26A and FIG. 26B illustrate embodiments for AI systems for analyzing wind effects on power cables in power lines;

FIG. 27 illustrates a handheld, high-resolution AI device having a high-resolution digital display viewed through an eyepiece; and

FIG. 28 illustrates an exemplary deep neural network for detecting wind speed and direction using an image of a string.

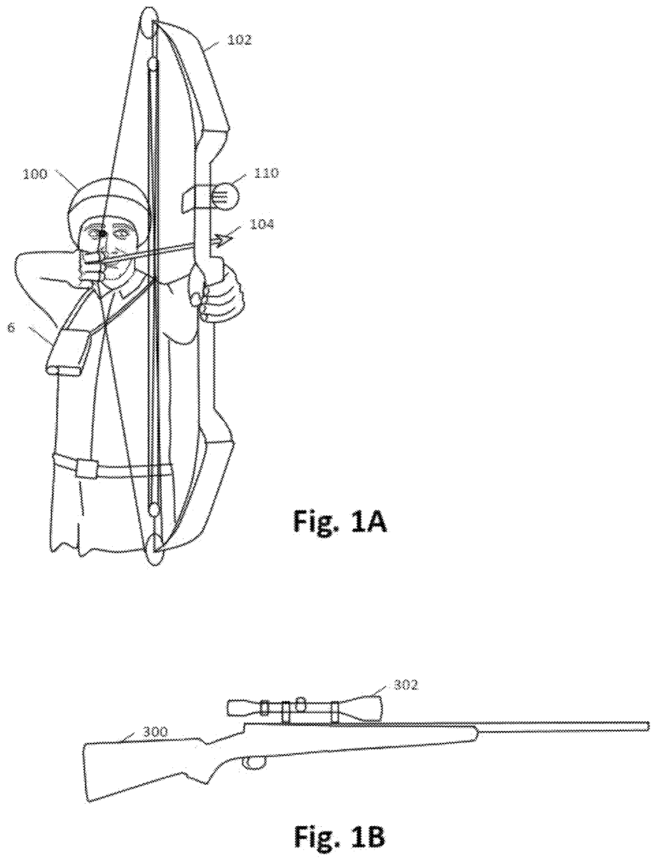

The drawing figures do not limit the present invention to the specific embodiments disclosed and described herein. The drawings are not necessarily to scale, emphasis instead being placed upon clearly illustrating the principles of the invention.

### REFERENCE NUMERALS IN DRAWINGS

2 projectile trajectory
3 line of sight
6 rangefinder
10 AI device
11 iPhone
13 range sensing means
15 9-axis sensor
16 computing element
18 memory
19 wireless communications
20 housing
21 alternate housing
22 eyepiece
24a-b lens
25a-c image sensor (digital camera)
26 distal end
28 proximate end
29 audio sensor
30 display
31 high-resolution display
32a-b inputs
35 visor or shroud
36a-b image
37a-d bounding point
38a-i fiducial point
39 battery compartment
40a-c string
48a-c wind
52 crosswind vector
56 tailwind vector
90 deer
98 drone
100 archer or user
102 bow
104 arrow
106a-f flexible rod
110 bow sight
199a-c extension
202a-c origin
204a-c far point
206 plate
250 detect string object
251 determine string origin & far point
252 calculate distance
253 calculate 3D yaw
254 calculate 3D pitch
255 angular line
256 calculate center and radius
257 find intercept
258 determine angle
259 calculate crosswind
300 rifle
302 scope
310 high-resolution AI device
410 monocular
522a-f insulator
524a-f power cable
526a-b power pole
530a-c center
532a-h radial point
534a-c radial arc
538a-c intercept
540 angular line
680a-c wind sensor
802a-c dark band
804a-b light band
900 crosshairs
914 horizontal distance indicator
922 crosswind indicator
924 green indicator
926 yellow indicator
928 red indicator
982 aiming point
1070 inserting end (male)
1072 receiving end (female)
1097 protrusion indicator
2235 horizontal leg
3094 locking channel
3104 sleeve
3196 outward protrusion
3450 stake
3454 stake member
A known height
B scale factor
C1 convolutional layer 1
C2 convolutional layer 2
C3 convolutional layer 3
C4 convolutional layer 4
C5 convolutional layer 5
C6 convolutional layer 6
C7 convolutional layer 7
D distance
H height
L 3D yaw
M 3D pitch
P_{0, 20, 100} point
pA parabola A
R radius
T target
V vertex

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### The String

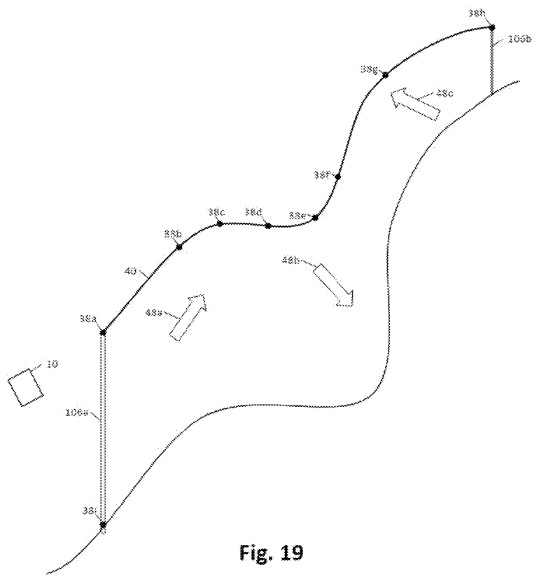

Over a decade ago we performed an experiment with a 270-yard string 40 supported by two flexible rods 106 in a harsh, rough environment with hills and valleys and strong winds at different speeds and directions (see FIG. 19) along the projectile trajectory path 2 to a target T (see 6B). We discovered that the “string is the teacher.” By observing the effects of the combined winds on the string, including both the sounds and the visual image of the string and the flexible rods, a human users could determine a period of consistent wind, adjust their aim for that wind, and repeatedly hit the target using that aim each time the users sensed the presence of the optimum steady wind conditions. The sound of the wind was easier to distinguish at higher wind speeds. In our experiment, the string taught us how to adjust our aim and when we could repeat a shot under the same and highly similar instantaneous wind conditions. The bullets consistently hit a desired target at 270 yards in strong dynamic wind conditions.

In our experiment, we used a 600-yard spool of 80-pound test Izorline braided low stretch Dacron fishing line, UPC 8783700307. The string was white with “greenspot” spiral markings.

We discovered that the string is the teacher. What was needed were low cost, light weight, portable platforms with high quality optics, digital camera, and computing capabilities so that we could implement a machine learning solution which could also be taught by the string and could instantaneously observe current wind effects and provide crosswind, headwind/tailwind, information; could determine a presence of a stable optimum wind, and display an adjusted aiming point. With advances in AI technology and platforms that can be made available to general users, we can now implement our invention as devices and methods for recognizing wind along a projectile trajectory path so that a user can accurately aim and hit a desired target regardless of the wind speed and direction at different points along the path, and provide an indication that wind currently is in a likely sustained favorable state for a brief period of time, such that a user has time to aim and fire.

More recently, we have experimented with supporting the string with flexible rods with equal height, e.g., 5-foot rods, preferably with 6-inch bands of darker color and/or reflective materials. We have experimented with different strings and have had good results with green mono filament line. To aid in recognizing the wind, by observing the string, it is useful to know the amount of string. An AI device can recognize the distance of an object of a known size, such as the flexible rod, animal, bird, or vehicle, by analyzing its visually apparent size in the image at a known magnification.

Accordingly, we disclose the following AI systems, devices, and methods.

### AI Device

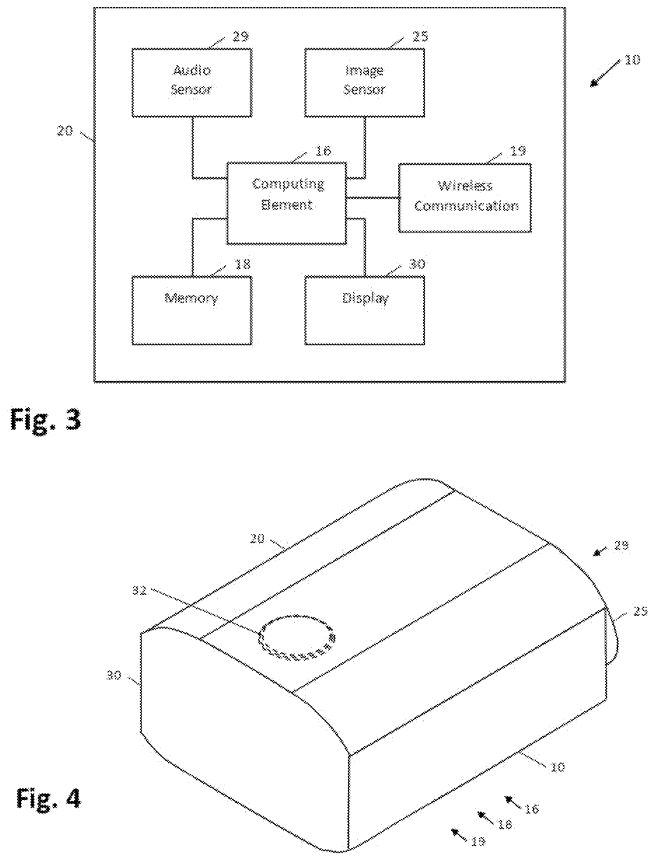

FIG. 3 illustrates our novel AI device 10 comprising a computing element 16, coupled with a memory 18, audio sensor 29 or an image sensor 25, a display 30, and wireless communications 19. A housing 20 contains the elements of the device 10.

FIG. 4 shows our novel AI device 10 comprising a housing 20 supporting a display 30, an operating button input 32. The components inside the housing 20 comprise: computing element 16, memory 18, wireless communications 19, image sensor (digital camera) 25, audio sensor 29. One or both, of the image sensor 25 and the audio sensor 29, is configured in different embodiments.

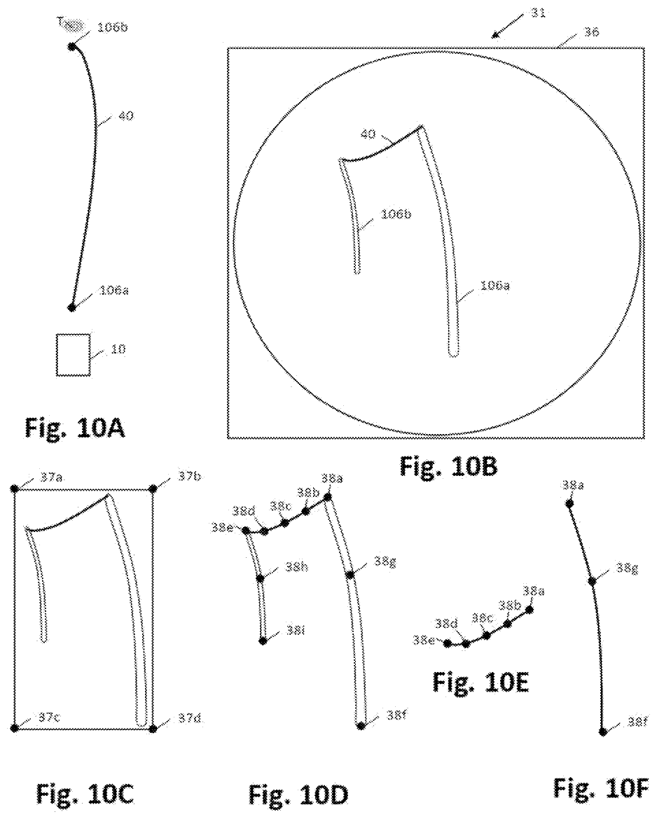

The display 30 could be a high-resolution, touch screen display 31 (see FIGS. 10B, 15A through 15C, 16, 17, 18, 20, 22, and 26B).

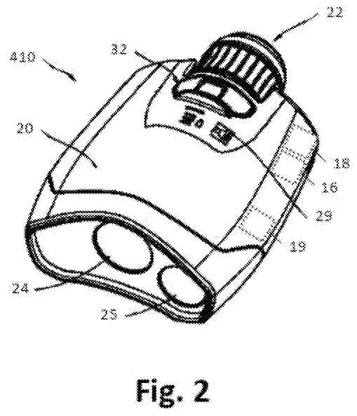

Comparing FIG. 4 to FIG. 2 results in understanding that while Swarovski binocular is an enabling platform for our present invention, it contains elements which are not required by our present invention. In other words, the reader should understand that the present invention could be implemented entirely on a Swarovski binocular or similar device but could also be implemented as disclosed herein without requiring the invention claimed by Swarovski. Further, Swarovski only clearly discloses identification of birds and mountain peaks. It is silent on determining range, on recognizing wind, or on projectile trajectory paths.

The handheld housing 20 enables AI device 10 to be easily and safely transported and maneuvered for convenient use in a variety of locations.

For example, the portable handheld housing 20 may be easily transported in a backpack for use in the field. Additionally, the location of the components on or within the housing 20 and the location of the button 32, enables AI device 10 to be easily and quickly operated by the user with one hand without a great expenditure of time or effort.

A computer program preferably controls input and operation of the AI device 10. The computer program includes at least one code segment stored in or on a computer-readable medium residing on or accessible by AI device 10 for instructing computing element 16, image sensor 25, audio sensor 29, and any other related components to operate in the manner described herein. The computer program is preferably stored within the memory 18 and comprises an ordered listing of executable instructions for implementing logical functions in AI device 10. However, the computer program may comprise programs and methods for implementing functions in the device 10 which are not an ordered listing, such as hard-wired electronic components, programmable logic such as field-programmable gate arrays (FPGAs), application specific integrated circuits, conventional methods for controlling the operation of electrical or other computing devices, etc.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

AI device 10 and computer programs described herein are merely examples of a device and programs that may be used to implement the present invention and may be replaced with other devices and programs without departing from the scope of the present invention.

The computing element 16 is coupled with image sensor 25, audio sensor 29, wireless communication 19, and optional accelerometers or gyroscopes, to determine ballistic information relating to the target T, including wind effect information, as is discussed herein. The computing element 16 may be a microprocessor, microcontroller, or other electrical element or combination of elements, such as a single integrated circuit housed in a single package, multiple integrated circuits housed in single or multiple packages, or any other combination. Similarly, the computing element 16 may be any element that is operable to determine clear shot information from the range and angle information as well as other information as described herein. Thus, the computing element 16 is not limited to conventional microprocessor or microcontroller elements and may include any element that is operable to perform the functions described.

The memory 18 is coupled with the computing element 16 and is operable to store the computer program and a database including trained representation and classification for comparison, and configuration information. The memory 18 may be, for example, an electronic, magnetic, optical, electromagnetic, infrared, or semi-conductor system, apparatus, device, or propagation medium.

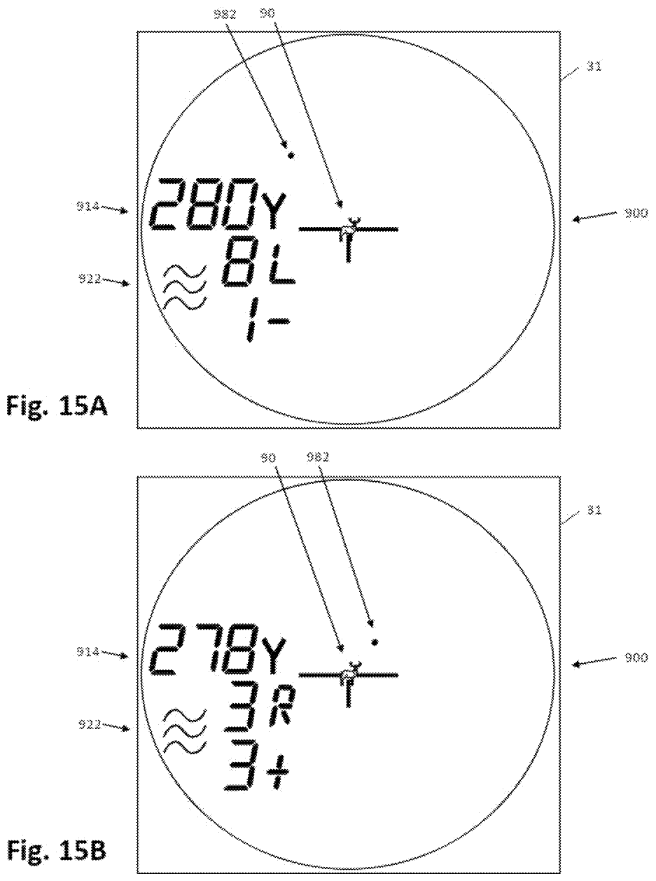

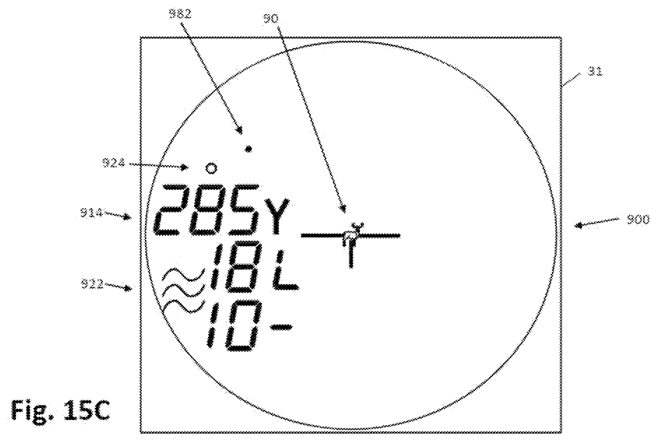

The device 10 also preferably includes a display 30 to indicate relevant information such as the crosshairs 900, horizontal distance indicator 914, and other indicators disclosed herein (e.g. FIG. 15A). The display 30 may be a conventional electronic display, such as an OLED, TLED LED, TFT, or LCD display, or a higher resolution pixel matrix, e.g., with a resolution of 304×256.

The inputs 32 are coupled with the computing element 16 to enable users or other devices to share information with AI device 10. The inputs 32 are preferably positioned on the housing 20 to enable the user to simultaneously view the display 30 and function the inputs 32.

The inputs 32 preferably comprise one or more functionable inputs such as buttons, switches, scroll wheels, etc., a touch screen associated with the display 30, voice recognition elements, pointing devices such as mice, touchpads, trackballs, styluses, combinations thereof, etc. Further, the inputs 32 may comprise wired or wireless data transfer elements.

### Training

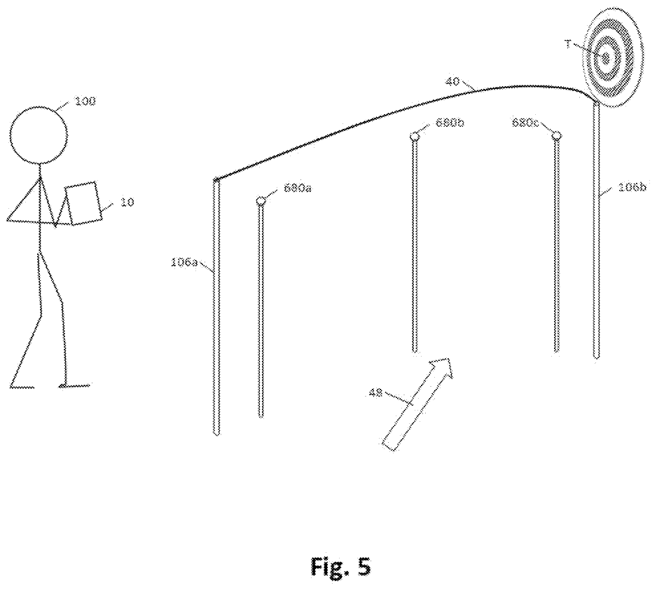

FIG. 5 illustrates the training of the AI device 10 with a string 40 and wind sensors 680a through 680c, positioned along a projectile trajectory path to a target T.

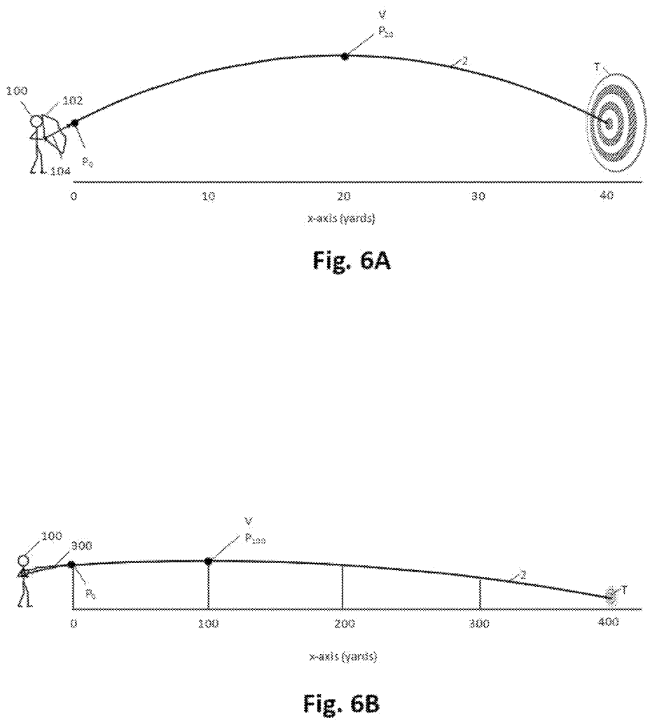

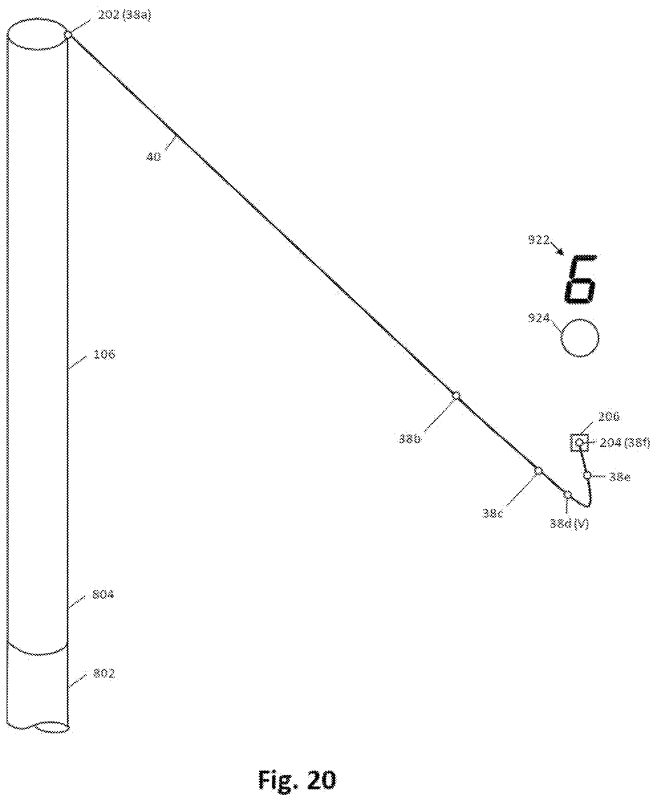

The user 100 is shown with the AI device 10. The string 40 is supported two flexible rods 106, namely near rod 106a and a far rod 106b. The rods 106 hold the string 40 off the ground in the wind 48 along at least a segment of the projectile trajectory path 2 (shown, for example, in FIG. 6A and FIG. 6B). In other embodiments for wind detection, the string could be attached to two fixed points one at each end (see FIG. 20).

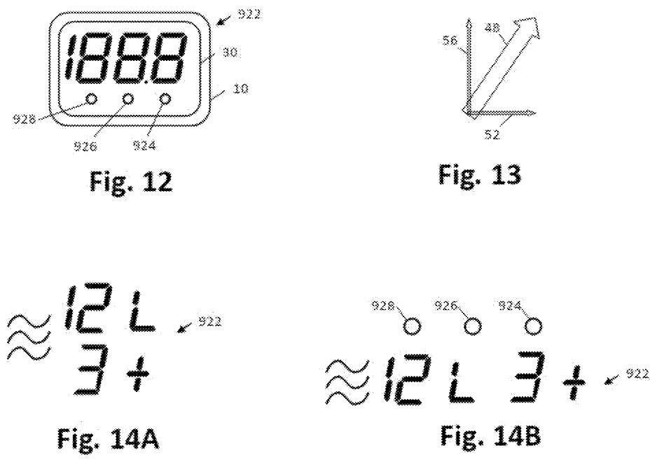

The string 40 shows that the wind 48 has both a tailwind and left moving cross wind (see FIG. 13). The tailwind is evidenced by the curve of the string 40 toward the target T, at the far rod 106b. The left moving crosswind is evidenced by the curve of the string 40 toward the left of the line of sight to the target, and to the left of the two rods 106.

The AI device 10 is positioned where it can sense the string 40 and the rods 106. In some embodiments, the AI device 10 senses the sound made by the wind 48 as it moves and passes over the string 40. In some embodiments, the AI device 10 senses the image made by the wind 48 as it dynamically moves the string 40 and flexes the rods 106. In other embodiments it senses both sound, with the audio sensor 29 (FIG. 3 and FIG. 4), and photos or videos, with the image sensor 25 (FIG. 3 and FIG. 4).

A plurality of conventional wind meters 680 (also known as anemometers) are shown positioned along path of the string 40.

Wind meters are well known in the art, such as Kestrel 1000 wind meter or the Kestrel 3550FW fire weather meter. Wind meters are known to provide wind direction and speed via wireless communications.

Our application Ser. No. 18/431,980 introduced a new class of anemometer, namely, a string anemometer which senses the wind along the full path to a target, not just a few finite points along the path.

Our U.S. Pat. No. 8,795,109, issued Aug. 5, 2014, and U.S. Pat. No. 9,482.505, issued Nov. 1, 2016, both included by reference, disclose and claim a wind tracking apparatus which can be deployed by shooting an arrow comprising a wind meter or wind sensor 680 on nock end of the arrow, which then wirelessly transmits wind speed and direction. One wind meter or sensor was disclosed as an ultrasonic anemometer.

A large multiplicity of images 36 (FIG. 10B) and/or audio are captured by an embodiment of the AI device 10, such as monocular AI device 410 of FIG. 2, or other conventional recording means such as cameras, audio records, or smart phones 11, such as iPhones. The multiplicity of images 36 (FIG. 10B) and/or audio are capture while observing the string 40 during thousands of different wind conditions. With each image or audio capture, the wind information from the plurality of wind meters 680 are received wirelessly and stored in a dataset along with each image or audio recording. The dataset is used as input to train the deep learning model of the AI device 10.

### Projectile Trajectory Paths

FIG. 6A illustrates an archer 100 with a bow 102 and the projectile trajectory path 2 of an arrow 104 to a target T. As discussed above the path is generally parabolic but is affected by many factors for the true ballistic path.

As shown in FIG. 6A the arrow starts at point P₀ and at 20 yards pass through point P₂₀, which is the vertex V of the projectile trajectory path 2, when aimed at a 40-yard target T.

FIG. 6B illustrates a user 100 with a rifle 300 and the projectile trajectory path 2 of a bullet to a target T.

As shown in FIG. 6B the bullet starts at point about 5 feet above the ground and then climbs to a vertex V at 100 yards, passing through point P₁₀₀, when the rifle 300 is aimed at a 400-yard target T. The vertex V about 5½ feet above the ground (e.g., 6-inch rise). The path is about 5 feet at 200 yards and 3½ feet at 300 yards. The path drops off quickly to the target during the last 100 yards as the bullet velocity drops due to wind drag.

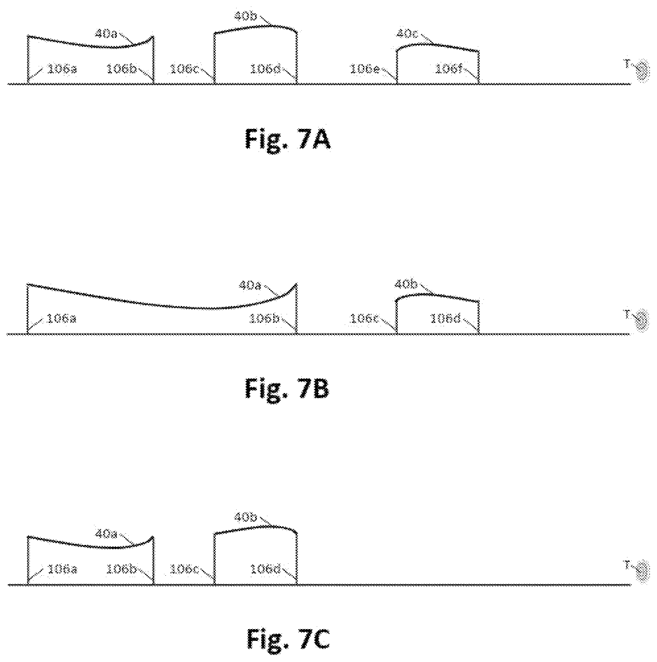

As seen in both FIG. 6A and FIG. 6B, the projectile trajectory path 2 is higher than the height at P₀. Accordingly, the wind may be different at different height, and it would be preferred to recognize the wind 48 at different heights (see e.g. FIG. 5 above and FIGS. 7A through 7C below).

### Multiple String Segments at Different Heights

FIGS. 7A through 7C illustrates a plurality of strings 40, each positioned at different segments and heights along a projectile trajectory path 2 (shown in FIG. 6A and FIG. 6B) to a target T. As shown in each figure, the wind's effect on the string 40 may be different in each segment.

FIG. 7A shows three strings 40a through 40c, respectively, supported by pairs of rods 106, 106a-b, 106c-d, and 106e-f, respectively. String 40b is supported at a higher position than string 40a. String 40c is supported at a lower position than string 40a. These heights correspond to the projectile trajectory path 2 for a rifle (shown in FIG. 6B). For example, string 40a is supported at 5 feet, string 40b is supported at 5½ feet, and string 40c is supported at 3½ feet. At these different heights the AI device 10 can better recognize the wind effect on the bullet, e.g., along projectile trajectory path 2 for a rifle (shown in FIG. 6B).

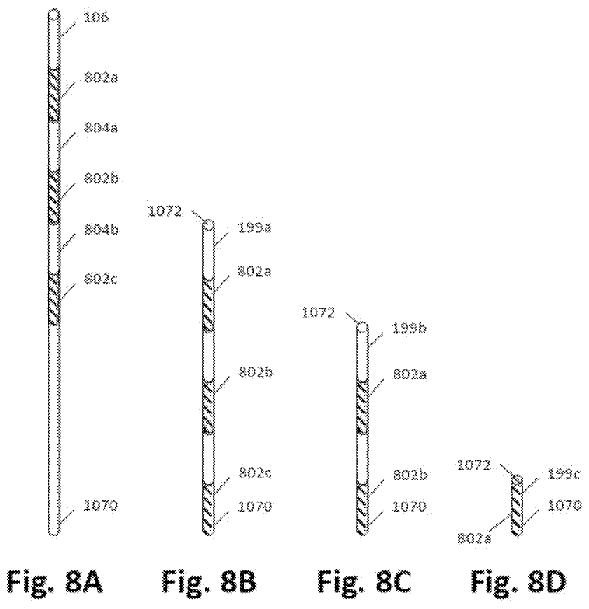

With preferred embodiments using banded rods, the AI device is better able to detect the rods and their height. For example, in this example, 5 feet (see FIG. 8A), 5½ feet (FIG. 8A combined with FIG. 8D), and 3½ feet (FIG. 8B combined with FIG. 8D), respectively.

FIG. 7B shows two strings 40a and 40b, respectively, supported by pairs of rods 106, 106a-b and 106c-d, respectively. String 40a is supported at a higher position along a relative longer segment.

FIG. 7C shows two strings 40a and 40b, respectively, supported by pairs of rods 106, 106a-b and 106c-d, respectively. String 40b is supported at a higher position near the vertex. String 40a would help detect the initial wind impact on the path. String 40b would detect the wind impact at the higher part of the path.

### Flexible Rods and Extensions

As shown in the previous figures, it is advantageous to have rods 106 of different lengths. FIGS. 8A through 8D illustrates a flexible rod 106 and extensions 199b, preferable marked with dark bands 802 and light bands 804.

FIG. 8A illustrates a flexible rod 106, preferable marked with dark bands 802 and light bands 804. Dark bands 802a, 802b, and 802c are preferably 6-inches long and are separated by 6-inch long light bands 804a and 804b. In this preferred embodiment the rod is 5 feet long, and the 3 feet are easily identified at the bottom of each dark band 802, namely, 1 foot at the bottom of 802a, 2 feet at the bottom of 802b, and 3 feet at the bottom of 802c. The bottom of the rod 106 is an inserting end 1070.

The dark bands 802 and light bands 804 of a predetermined length aid the AI device is detecting the location and flex of the rod 106. Further, the AI device determines the distance from the AI device to each rod 106 and determines length of the string based on the distance between the near rod 106a and the far rod 106b (FIG. 5). While not required, the dark bands 802 and light bands 804 enhance the captured images 36 (FIG. 10B) and improve the rod 106 and string 40 recognition, detection, and alignment.

FIG. 8B illustrates a 3-foot rod extension 199a, preferable marked with dark bands 802 and light bands 804.

FIG. 8C illustrates a 2-foot rod extension 199b, preferable marked with dark bands 802 and light bands 804.

FIG. 8D illustrates a 6-inch rod extension 199c, preferable marked with a dark band 802.

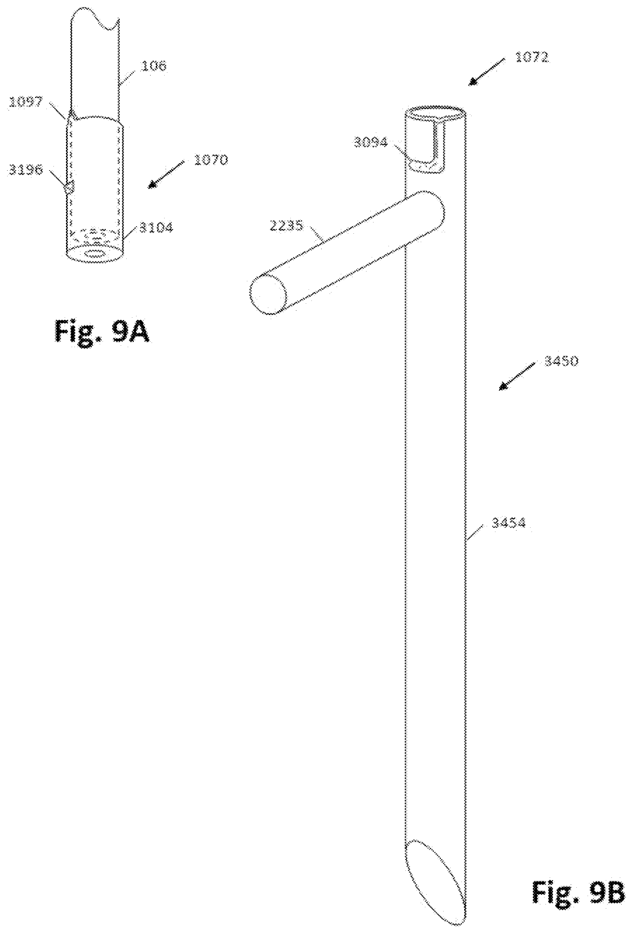

The bottom of each rod extension 199 is an inserting end 1070. The top of extensions 199a-c are receiving ends 1072 (see FIG. 9B), each configured to receive an inserting end 1070.

The different rod 106 and rod extension 199a through 199c sizes provide for configuration of support rods 106 of different lengths. However, the rod 106 can be broken down and carried in a smaller bag. A 5-foot rod 106 is configured from a 3-foot extension 199a and 2-foot extension 199b. All three extensions 199a-c could be configured for the 5½ foot support needed to place a wind sensor 680 at P100 in FIG. 6B.

FIGS. 9A and 9B illustrates lockable inserting ends 1070 and receiving ends 1072 for embodiments of the flexible rod and extensions. FIG. 9B further illustrates a ground stake 3450 for supporting any rod assembly (comprising rod 106 and extensions 199).

Our U.S. Pat. Nos. 7,841,355 and 8,789,550 disclose sleeve 3104 having an outward protrusion 3196 and protrusion indicator 1097, shown on the inserting end 1070 in FIG. 9A, and a locking channel 3094 on the receiving end 1072 and a ground stake 3450 as shown in FIG. 9B.

The ground stake 3450, in addition to the locking receiving end 1072, comprises a pointed stake member 3454 for insertion into the ground, and a horizonal leg 2235 which aids ground insertion and removal. For example, a user steps on the horizontal leg when placing the rod 106 in the ground.

Each of the inserting ends 1070 rod 106 and rod extension 199a through 199c can be inserted and locked into any of the receiving ends 1072 of rod extensions 199 and the ground stake 3450, to configure a flexible rod 106 which can be removably placed in the ground.

### Deep Learning Model Use and Operation

FIGS. 10A through 10F illustrates the use and operation of the AI device 10.

FIG. 10A illustrates positioning the AI device 10, flexible rods 106a and 106b, and the string 40 along a projectile trajectory path to a target T. The AI device should be positioned about six feet from the near rod 106a with a full view of the string 400 and both rods 106a and 106b. This is the positioning step.

FIG. 10B illustrates an image 36 captured by the AI device 10. The image is displayed on a high-resolution display 31, showing the shape and position of the string 40. The image 36 also shows the flex and relative positions of the flexible rods 106a and 106b, which also mark the ends of the string 40. This is the capture step.

FIG. 10C illustrates a detection crop from the image 36 with four bounding points 37 forming a bounding rectangle containing the cropped image of the string 40 and rods 106, which is cropped from the image 36 of FIG. 10B. This is the first part of the detection step.

FIG. 10D illustrates fiducial points 38 found on the string and rods of the cropped image of FIG. 10C. Fiducial points 38a through 38e mark the curve of the string in the cropped image. Fiducial points 38a and 38f mark the ends of the near rod in the cropped image. Fiducial points 38e and 38i mark the ends of the far rod in the cropped image. Fiducial points 38a, 38g, and 38f mark the curve of the near rod. Fiducial points 38e, 38h, and 38i mark the curve of the far rod. Determining the fiducial points 38 is the second part of the detection step. The tar weight of the string plus the collective force of the wind against the string pull the rods toward each other, such that the direction of the flex of the rod is parallel with the string. A pulley near the near rod allows the direction flex of the rod 106a to be rotated, e.g., 90 degrees, such that the same camera captures the shape of the string 40 and the flex of the near rod 106 in the same image (not shown).

Knowing the focal magnification of the image, and preferably using the dark band 802 and light bands 804 visualized in the captured image, the computing element 16 (FIG. 3 and FIG. 4) can determine the distance of the near rod 106a from the image sensor 25, the distance from the near rod 106a to the far rod 106b which is the same as the length of the string 40, and the length of the rods 106. Later, the alignment step uses these length and distances to scale the cropped image.

The distance of the near rod 106a from the image sensor 25 optionally is an input to the deep learning model.

In another embodiment the AI device 10 measures the height of the portion of the near rod 106a (e.g., by using the bottom of the dark bands 802a, 802b, 802c) in pixels, and determines the distance from the camera to the near rod 106a.

The distance from the near rod 106a to the far rod 106b provides information regarding the tar weight of the string, which may be an input to the deep learning model, and an input to the trained model when determining the wind direction and speed.

FIG. 10E illustrates fiducial points 38 defining the shape and position of the string (in this case 38a through 38e).

FIG. 10F illustrates fiducial points 38 defining the flex of a flexible rod (in this case 38a, 38g, and 38f) showing the curve of the near rod 106a.

Next in the alignment step, the cropped image scaled to a standard size. The length of the near rod 106a is used as the standard for scaling. Thus, the user can place the AI device 10 at any reasonable distance from the near rod 106a. This removes the need for the user to measure the placement for accuracy of the deep learning model.

DeepFace teaches that near 100% face recognition can be achieved with both 2D rotation and 3D alignment. Alignment is optional. In our preferred embodiment, 3D alignment using the fiducial points 38, as well as determined lengths and distances, is used to align the top of both rods 106a and 106b in the center of the aligned image such that the flex of both rods and the entire string 40 curve(s) are visualized in the aligned image. This removes the need for the user to worry about the height or exact placement of the AI device 10 when capturing images.

These comprise the alignment step. The alignment is applied by transforming the fiducial points. After the fiducial points have been aligned, the image pixels are no longer needed,

[symbol]

The cropped, scaled, 2D aligned, and optionally 3D aligned fiducial points for each of a multiplicity of images 36, as well as the wind sensor information captured at the same time as the image, are given as inputs to the deep neural networks (DNN). Optionally, a concurrent sound recording is converted to a spectrogram and the spectrogram fiducial contours are given as an input to the DNN.

The DNN is trained on the wind recognition task with a goal of output a wind direction and speed in relation to the directional alignment of the bottom of each rod 106 (which represents the direction of the target T. In a currently preferred embodiment, there is no need to visualize or detect the target itself. This simplifies the parameters of the DNN.

In simple terms, the DNN is used to classify the multiplicity of images 36 to a particular crosswind class (and optionally headwind/tailwind class). Once trained the AI device 10 can classify a single new image and/or sound, and output a particular crosswind and tailwind based on a matching class. See operation below.

In practice, a very small percentage of shots need to be taken in winds greater than 30 m.p.h. (miles per hour). Thus, the ability to identify 60 distinct classes for cross wind (e.g., 30 from left cross winds from 0 to 30 m.p.h. and 30 for right cross winds from 0 to 30 m.p.h.) should be sufficient for general hunting or target shooting applications. Our model thus is less complex, smaller, and faster than the DeepFace model.

DeepFace also teaches that the number of layers in the DNN can be varied to simplify or to enhance the error rates. Accordingly, one skilled in the arts of computer vision and machine learning, and in particular DNN-based image classification would be able to modify the DNN to meet their particular needs and parameters of their product (such as process speed, memory size, battery life, etc.).

In one embodiment of the DNN, only the string fiducial points 38 (e.g. 38a-e FIG. 10D and FIG. 10E) are used. In another embodiment of the DNN only the rod fiducial points 38 (e.g. 38a, 38g, and 38f or 38e, 38h, and 38i of FIG. 10D) are used. In yet another embodiment only the near rod 106a fiducial points (e.g. 38a, 38g, 38f of FIG. 10D and FIG. 10F) and the sound fiducial contours are used. To be clear, each input is labeled with sensed wind values from one or more wind sensors 860.

In yet other embodiments, the strings 40 and rods 106 are positioned at an angle such as a 90-degree angle from each other.

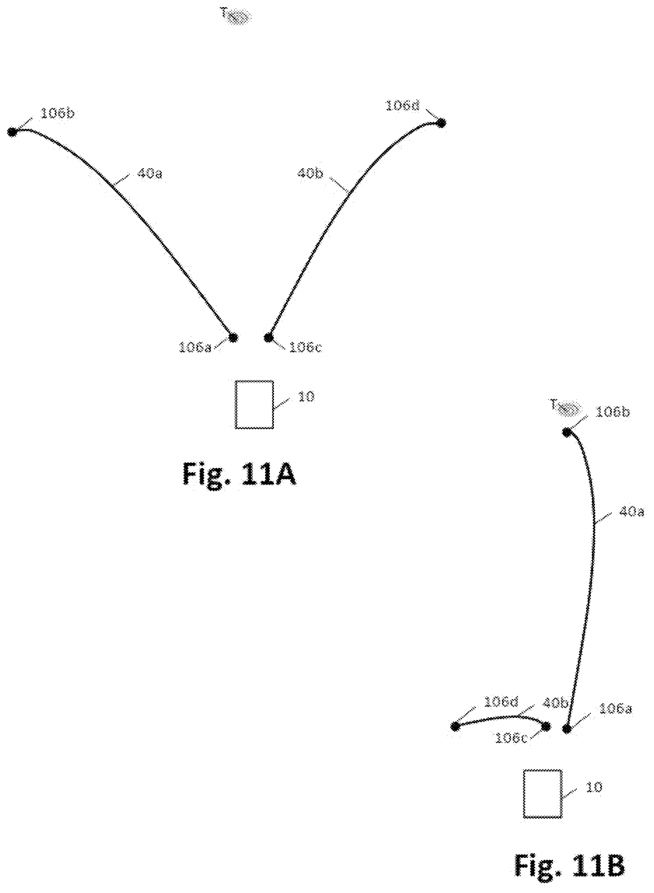

FIGS. 11A and 11B illustrate a plurality of strings 40, each positioned at different angles relative to the projectile trajectory path to the target T. Both FIG. 11A and FIG. 11B illustrate the placement of AI device 10.

FIG. 11A illustrates a left string 40a supported by rods 106a and 106b generally angled 45 degrees to the left of the target T, and a right string 40b supported by rods 106c and 106d generally angled 45 degrees to the right of the target T, such that the strings 40a and 40b generally form a 90-degree angle.

FIG. 11B illustrates a string 40a supported by rods 106a and 106b generally angled along the projectile trajectory path to the target T, and a tailwind string 40b supported by rods 106c and 106d generally angled 90 degrees generally on a line perpendicular to the target T, such that the strings 40a and 40b generally form a 90-degree angle. String 40b is much shorter than string 40a, as its role is to measure headwind and tailwind relative at the origin of the shot, and so it is more easily visualized in the field of view of the AI device 10. The embodiment shown in FIG. 11B is currently preferred over the model shown in FIG. 10A when headwind/tailwind output is desired from the DNN.

### Field Use and Operation of the Trained AI Device

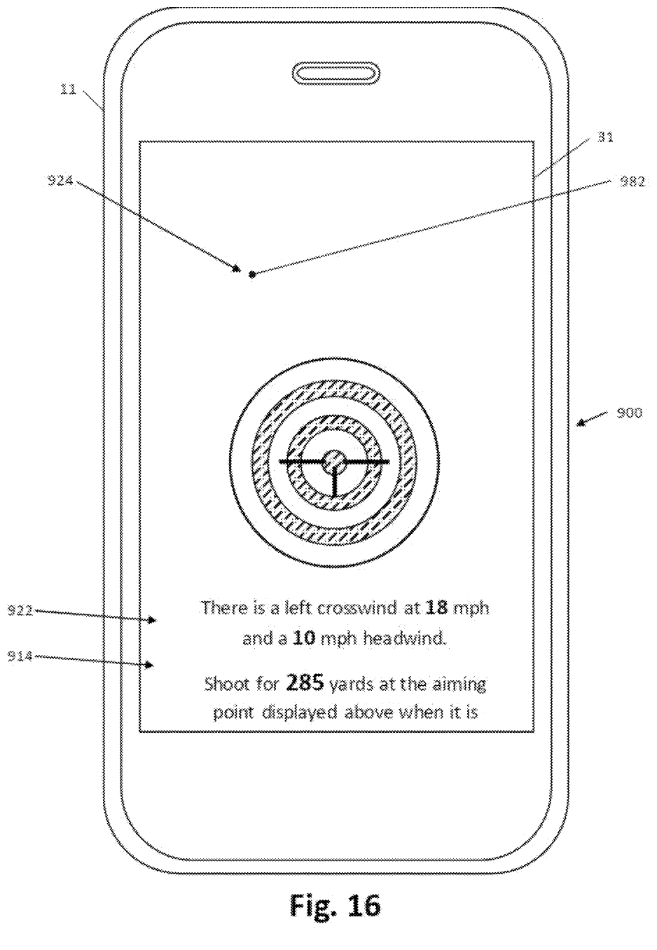

FIG. 12 shows an embodiment of display 30 as shown for example on the form factor of the AI device 10 shown in FIG. 4. This embodiment does not require a high-resolution display 31 (for example, as shown in FIG. 10B, FIGS. 15A through 15C, or FIG. 16). This embodiment of AI device 10 may be carried by hand or mounted in a fixed position, such as on a tripod at a shooting range or on a tree stand or in a hunting blind. Under one setting it operates automatically to periodically display crosswind information, in a crosswind indicator 922, and, optionally, display the state of a steady optimum wind condition by illuminating at green indicator 924. A yellow indicator 926 indicates that the optimum wind condition is approaching. The red indicator 928 indicates that the wind is too strong or unpredictable at the moment.

FIG. 13 illustrates crosswind and tailwind vector elements of wind 48, namely crosswind vector 52 is the crosswind element and tailwind vector 56 is the tailwind vector which is in the negative director for headwind.

FIGS. 14A through 14B illustrate embodiments of display 30 or high-resolution display 31 elements with crosswind speed indicators and with headwind/tailwind speed indicators as part of crosswind indicator 922. A wind icon is shown as three waves as a visual clue to the viewer. As shown the current crosswind has been recognized as 12 m.p.h. moving to the left as indicated by “12 L” and there is a 3-mph tailwind as indicated by the plus sign in “3+”. FIG. 14B further includes indicators of a steady state of optimum wind, namely the green indicator 924, yellow indicator 926, and red indicator 928, as described above.

FIGS. 14A through 14B are based on the crosswind vector 52 and tailwind vector 56 in relation to the wind 48 relative to the path to the targets (see FIG. 13).

The handheld portable use and operation of trained AI device 10 is now discussed in more detail.

In operation, the user aligns AI device 10 with the target T and views the target T on the display 30. The AI device 10 may provide generally conventional optical functionality, such as magnification or other optical modification, by utilizing a lens 24 and/or the computing element 16. Preferably, the device 10 provides an increased field of vision as compared to conventional riflescopes to facilitate conventional view functionality. The focal magnification typically is 4×, 5×, 7×, 12× and so forth. In some embodiments the magnification factor is variable, such as with a zoom feature. This magnification value is used by the computing element 16 in performing the mapping of the various indicators, and operating the deep learning model on the captured image is discussed in reference to FIGS. 10A through 10F above.

Further, the user may function the inputs 32 to control the operation of AI device 10. For example, the user may activate AI device 10, provide configuration information, and/or turn on or off automatic operation, or manually initiate a capture and recognition sequence by functioning one or more of the inputs 32.

### High-Resolution Display Use and Operation

FIGS. 15A through 15C illustrate a high-resolution display 31 showing an aiming point 982 based on a projectile trajectory path adjusted for wind using the deep learning model of the present invention. The crosshairs 900 are used to aim the AI device 10 towards the target (deer 90), providing an input to the deep learning model the direction of the line of sight to the target. It also displays the captured image 36 for recognizing current wind (as shown in FIG. 10B).

FIGS. 15A and 15B each shows a high-resolution display 31 providing digital video superimposed with horizontal distance indicator 914, crosswind indicator 922, and adjusted aiming point 982. The adjusted aiming point 982, in this embodiment, doubles as the green indicator 924.

FIG. 15A shows an output from the deep learning model. There is an 8-mph cross wind moving left and a 1-mph headwind. The user is guided to shoot for 280 yards at the dynamically moving adjusted aiming point 982 when it turns green.

FIG. 15B shows an output from the deep learning model after the wind has shifted. There is a 3-mph cross wind moving right and a 3-mph tailwind. Accordingly, the user is guided to shoot for a shorter distance of 278 yards at the dynamically moving adjusted aiming point 982 when it turns green.

FIG. 15C shows yet another embodiment where green indicator 924 is in a permanent position near the center of the user's field of vision. The wind is much stronger. There is an 18-mph cross wind moving left and a 10-mph headwind. Accordingly, the user is guided to shoot for a longer distance of 285 yards at the dynamically moving adjusted aiming point 982, when the separate green indicator 924 is illuminated.

### High-Resolution Digital Display

FIG. 16 shows a high-resolution display 31 providing digital video superimposed with crosshair 900, horizontal distance indicator 914, crosswind indicator 922, and adjusted aiming point 982. The adjusted aiming point 982, in this embodiment, can double as the green indicator 924. This embodiment has very simple use for the operator, for example, the text on the screen simply states, “There is a left crosswind at 18 m.p.h. and a 10-m.p.h. headwind. Shoot for 285 yards at the aiming point displayed above when it is green,” or even simpler “Aim at the dot and shot when it turns green.”

This simple embodiment is an example of our best mode embodiment which we intend to market under the AimFinder™ trademark.

FIG. 16 shows a digital, high-resolution display 31, in this example, a touch screen display of an Apple iPhone 11.

One advantage of a digital, high-resolution display 31 is that it is not limited to the circular optical focus area. The additional area of the rectangular display can be used for various purposes. Information can be moved outside the circular focus area, for example, to the lower corners and bottom of the screen. This has the advantage of allowing the circular focus area to be less cluttered and to obscure less of the optical image information. Further, the rectangular high-resolution display 31 can provide more optical information.

Another advantage of a high-resolution display 31 is that the overlay information is produced by software rather than by a hardware chip. Custom hardware chips can be expensive to design and manufacture and are less flexible. The overlay information generated by software for display on the high-resolution display 31 is higher quality, such as easier to read fonts, and move flexible, such as being able to display in different colors or locations of the screen to avoid obscuring the optical information being overlaid. The display can have more options, such as natural languages, different number systems such as Chinese, different units of measure, and so forth. Further, the software can be easily updated to incorporate new features, to improve calculations, or to support addition projectile information. Updates can be made in the field as well as in new models at a lower cost. For example, in some embodiments, new software can be downloaded over the Internet.

### High-Resolution Touch Screen Display

FIG. 16 also shows an exemplary touch screen display as an embodiment of the high-resolution display 31. The high-resolution display 31 displays the video image as digitally captured by the digital camera 25 (see FIGS. 3 and 4).

The embodiment shown comprises a mobile smart phone, in particular an Apple iPhone 11. Correlating FIG. 3 with FIG. 16, the computing element 16 is the processor of the iPhone 11; the memory 18 is the memory of the iPhone 11; a 9-axis sensor 15 (not shown) is the 3-axis magnetic compass, 3-axis gyroscope, and 3-axis accelerometer of the iPhone 11; and the display 30 is the touch screen display of the iPhone 11, an embodiment of the high-resolution display 31.

### Digital AI Devices

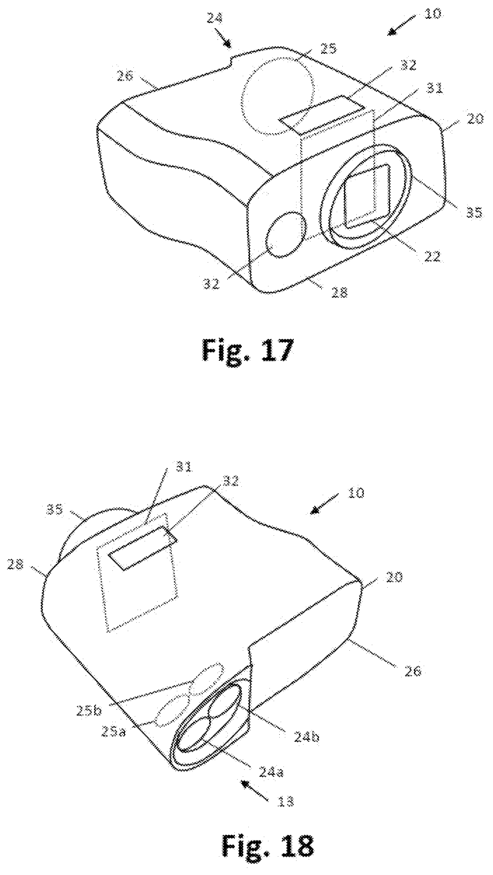

FIGS. 17 and 18 are rear and front perspective views, respectively, of digital embodiments of AI device 10.

The digital AI device 10 comprise a housing 20, having an eyepiece 22 at the proximate end 28, a lens 24, an optional range sensing means 13 (not shown), and inputs 32 in various places on exterior. In contrast to the conventional rangefinder, the housing 20 contains an image sensor (digital camera) 25 that captures and digitizes video from the optical image through the lens 24 and contains a digital, high-resolution display 31. The video comprises a series of image frames. The computing element 16 (FIG. 3) processes the image frames, overlays each frame with various indicators, and displays the resulting image on the high-resolution display 31. Further, the high-resolution display 31 is controlled completely by the computing element 16 (FIG. 3) and need not display any of the optical image being captured; instead, the high-resolution display 31 may display setup menus, recorded video, or annotations generated by the computing element 16 (FIG. 3).

FIG. 17 shows at least one lens 24 and at least one image sensor 25.

FIG. 18 shows an embodiment with two lens 24, namely, a low magnification lens 24a and a high magnification lens 24b; and two digital camera image sensors 25, namely, a low magnification image sensor 25a and a high magnification, preferably higher resolution, image sensor 26b. The low magnification lens 24a is in the range between 4× and 12×. The high magnification lens 24b is in a range greater that 20×, and preferrable would provide pixel detail of a target object at a distance between 400 yards and 1000 yards.

The eyepiece 22 may also be modified to accommodate viewing of the high-resolution display 31. In particular, the eyepiece 22 may be inset and be protected by a shroud 35.

In contrast to the conventional rangefinder housing 20 as shown in FIGS. 14 and 15, the housing 20 of the digital rangefinder of FIGS. 17 and 18 is more compact, more lightweight, and easier to transport and use, due to removal of the end-to-end optics, and the optional removal of the laser related electronic components and lenses. For example, the length between the proximate end 28 and the distal end 26 is shown as less than about four inches. The width and height could be about two inches, respectively.

### AI Devices Comprising Mobile Smart Phones and Tablets

In addition to the AI advantages of the present invention, embodiments comprising mobile smart devices, such as iPhone 11 or Android (e.g., Samsung, LG, Lenovo, Amazon, etc.) have several advantages over conventional rangefinders. First, the user has one less item to carry; this reduces the overall weight and complexity. Second the range finding device has a lower incremental cost to manufacture, being just the alternate housing 21 and the range sensing means 13 (not shown). The processor (computing element 16), 9-axis sensor 15 (not shown), digital camera 25, high-resolution display 31, and inputs 32 (including touch screen display inputs 34) of the mobile smart device is used to provide the necessary components of the digital rangefinder device 10. Third, the mobile smart device, such as iPhone 11, has other useful features such as global positioning system (GPS), virtual maps, satellite images, emergency communications, video capture, video playback, digital photographs, etc.

Advantages of mobile smart devices are explained with an exemplary scenario. The user uses the GPS and satellite images to travel to a hunting spot identified on a previous trip; however, the topographical maps and satellite images allowed the user to find a more direct, shorter route. A group of targets are in thick brush. Zoom video is taken showing the details of the targets such as which are does and bucks, number of points on the antlers, size of the animals. The dynamic clear shot trajectory mode is used to identify potential obstacles and to position the user and the weapon for a clear shot. The photo is marked with the GPS coordinates and time. The photo image may be uploaded to the deep learning training dataset. A second video is captured showing an animated projectile trajectory 2 path from a straight view. The motion sensors of the iPhone 11 are used to determine any projectile inertia. A third video is captured showing the animated projectile trajectory 2 path from a side perspective view. The firing device is aimed based on the information provided by AI device 10. When the projectile is fired, a fourth video is captured showing the actual projectile trajectory 2 and the success or failure of the shot. The success of the AI device prediction is scored. If Internet access is available via WiFi or via cellular wireless, the photo and videos can be uploaded to friends, video producers, or social networking sites, as well as deep learning training dataset. Any of the videos can be replayed.

In yet another more sophisticated embodiment of a very smart rangefinder device 10, an analysis of the second video can be compared to an analysis of the fourth video and AI device 10 can automatically recalibrate to match the true trajectory captured in the fourth video. The true parabola values, the air drag, and the crosswind drift can be determined and used for developing a training set for a future embodiment.

### Complex Harsh Natural Environments

FIG. 19 illustrates a string 40 and flexible rods 106a and 106b placed in a harsh, rough environment with hills and valleys and strong winds at different speeds and directions along the projectile trajectory path. The terrain causes different wind represented by wind 48a, 48b, and 48c. Wind 48a is illustrated going up the near hill toward the target T. Wind 48b is shown as an opposing cross wind moving right along the valley and adjacent cliff. Wind 48c is shown with a right crosswind and a slight headwind from wind coming over the taller mount crest.

The reader will see that the fiducial points 38a through 38h is a more complex curve. Such a curve may be too difficult for a human to interpret in a short enough time to make an ethical shot. However, the present invention (AI device 10) provides the possibility of rapid accurate analysis faster than a human.

### Using Machine Learning to Detect Fiduciary Points on a String and Determine Crosswind

FIG. 20 illustrates a string 40 supported by a rod 106 at the origin 202 and attached at the far point 204 to a plate 206. The string 40 forms a parabola having a minimum point or vertex V. A machine learning model is trained using a multiplicity of images of strings.

The AI device 10 (which is displaying this figure) determines and displays fiducial points (38a through 38f) along the parabola. In this example the origin 202 is fiducial point 38a and the far plate 204 is fiducial point 38f. The vertex V is fiducial point 38d. Fiducial points 38b, 38c and 38e are selected based on about 20%, 25%, and 75% of the horizontal distance to the far point 204. The machine learning model is trained with a multiplicity of images having these fiducial points (38a through 38f) marked on each image as well as an indication of the wind speed (preferrable both crosswind and tailwind).

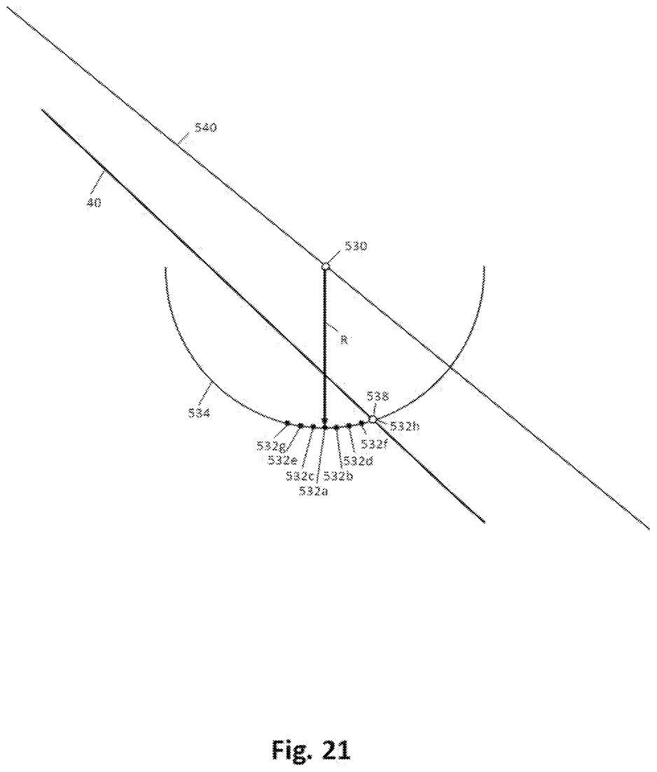

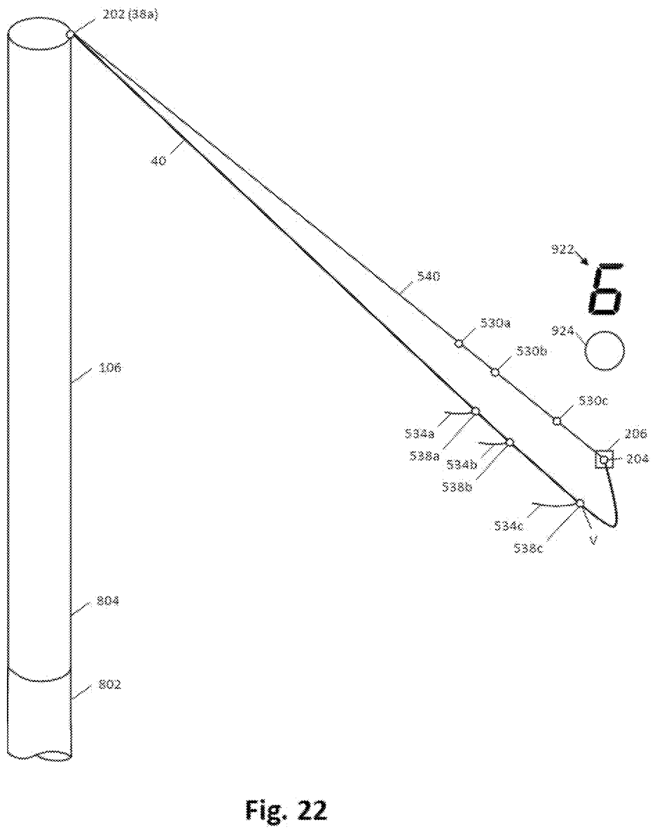

The AI device 10 determines the crosswind speed and displays it in the crosswind indicator 922 (e.g. 6 m.p.h.) as discussed above. In deep neural network embodiments, the cross wind and tail wind are outputs of the classifiers. However, we discovered that we could also determine the crosswind speed algorithmically by mapping the parabola in the image to 2D pixel coordinates as explained below in reference to FIG. 21 and FIG. 22.

The AI device 10 determines the steady state of optimum wind and displays indicators of a steady state of optimum wind, namely the green indicator 924 (shown), yellow indicator 926, and red indicator 928, as discussed above.

### Mapping Real-World Angular Measurements to 2D Pixel Coordinates

The rod 106 has a 6-inch light band 804 above a dark band 802. The plate 206 is preferrable a 12-inch square with a bright red or orange color for easy recognition in an outdoor environment. The range to the rod 106 is only a few inches but can be confirmed by the AI device 10 using the known height A of 6 inches (or 0.167 yards). The range to the far point 204 attached to the plate 206 can be calculated using the known height A of 12 inches (0.333 yards).

Each of these objects have a generally well-known size. The AI device 10 is set with a known magnification for each input camera and lens and a pixel height and width for each image. The AI device 10 calculates a distance based on measured number of pixels in the image and the known size. In our calculations A is the known height in yards e.g. 0.167 yards for the light band 804 and 0.333 yards for the plate 206.

For an iPhone 14 Pro, we determined an angular distance scale factor B of 2855 pixels per radian. Pixels per radian is calculated by dividing the pixel width of the sensor by 2 times the arc tan of the sensor width in mm divided by 2 times the focal length in mm. The sensor in the iPhone 14 is 4030×3024 in pixels for still images, or approximately 9.9 mm wide by 7.3 mm high. The focal length is 24 mm.

The range is calculated with the equation range=A/(2 tan(y/2*B), where A is the known height in yards, pixels per radian, y is the object height in pixels.

As shown in FIG. 22, the AI device 10 calculates and optionally displays an angular line 540 between the origin 202 and the far point 204. In this example, the far point 204 is 80 yards away from the origin 202. The range or distance D is 80 yards. The angular line 540 is the x-axis for a 2-dimensional (2D) model of the parabola, where the origin 202 is at x,y coordinates 0,0 and the far point 204 is at x,y coordinates 0,80. If the origin 202 and the far point 204 are at the same level, the midway point (e.g. center 530c in FIG. 22) on the angular line 540 will be at x,y coordinates 0,40. The AI device can measure the distance between midway point on the angular line 540 and the vertex V to determine the height H of the parabola. In this example H is −1.0 yards. The parabola A (pA) constant is calculated as pA=−H/(D/2)²·pA=−(−1.0)/(80/2)²=0.000625. The parabolic function of x, F(x)=pA*x*(x−D), which will give the y value for any point along the parabola (as indicated by the x value).

For analysis of the image of the string 40 in FIG. 22, the 2D model of the parabola is mapped to the 2D pixels coordinates of the image.

The origin 202 is identified in pixel coordinates in the image, for example, 270, 695. Variables origin_x and origin_y are used to apply the origin location, e.g. origin_x=270 and origin_y=695. The AI device 10 optionally draws a circular dot on the display 31 centered at origin_x, origin_y. The rod 106 has a 6-inch light band 804 above a dark band 802. Its distance is relatively close to the camera, so determining its distance is possible but not necessary in most situations.

The far point 204 is identified in pixel coordinates in the image, for example, 270, 695. Variables far_x and far_y are used to apply the far location, e.g. far_x=270 and far_y=695. The AI device 10 optionally draws a circular dot on the display 31 centered at far_x, far_y.

The AI device 10 optionally draws the angular line 540 on the display 31 from points (origin_x, origin_y) to (far_x, far_y).

The camera is positioned with a certain perspective in relationship to the string 40. In order to correlate the pixel coordinates of the 2D image with the x,y coordinates of the parabolic model, the 3D yaw L and the 3D pitch M of the camera perspective must be determined. For example, the 3D yaw L and the 3D pitch M can be visualized in FIG. 22 by observing the origin 202 and the angular line 540. The angular line 540 is yawed to the right and is pitched down. In this example, the 3D yaw L is 6.24075 radians, and the 3D pitch M is 0.03395 radians.

The pixel coordinates for the far point 204 may be calculated as far_x=origin_x+(D*sin(−L)*pixel_scale) and far_y=origin_y+((−D*cos(−L))*sin(M))*pixel_scale). Where, for example, pixel_scale is 342 for video images and pixel_scale is 958 for still photos from an iPhone 14 Pro.

When the wind blows, string 40 will generally maintain its parabolic shape and any point on the string 40 will rotate in a circular radial arc 534. For example, the vertex V will rotate around a center 530c point on the angular line 540 along radial arc 534c. The radial arc 534 is in a plane perpendicular to the plane of the parabola in the 2D parabolic model. The current position of the string 40 will intersect the calculated radial arc 534 at an intercept 538. For example, the vertex V is shown intersecting the radial arc 534c at intercept 538c.

In some embodiments, the crosswind calculation is a function of an angle between a) a line from the center 530 point on the angular line 540 and the corresponding fiduciary point 38 determined by a shape predictor and a line from the center 530 point on the angular line 540 and the minimum point on the radial arc 534. For example, the fiduciary point 38d (FIG. 20) vortex V of the center 530c point (FIG. 22) is angled to the right of minimum of the corresponding radial arc 534c, indicating a 6-m.p.h. crosswind, shown displayed in the crosswind indicator 922.

The AI device 10 determines the steady state of wind and displays indicators of a steady state of wind, namely the green indicator 924 (shown), yellow indicator 926, and red indicator 928, as discussed above.

In other embodiments, the crosswind calculation is a function of an angle between a) a line from the center 530 point on the angular line 540 and the corresponding intercept 538 point determined by algorithmically as discussed in more detail below regarding FIG. 21 and a line from the center 530 point on the angular line 540 and the minimum point on the radial arc 534. For example, in FIG. 22, the intercept 538c vortex V of the center 530c point is angled to the left of minimum of the corresponding radial arc 534c, indicating a 6-m.p.h. crosswind from the right.

Due to the perspective captured by a camera in a digital image 36, the points along the string 40 closer to the camera have greater precision (i.e. more pixels) in the range of movement along the radial arc 534. We found good results by selecting three distances along the angular line 540, i.e. 20% of the distance D, 25% D, and 50% D, shown in FIG. 22 as center 530a, 530b, and 530c, which are the centers for calculating the radial arcs 534a, 534b, and 534c, respectively.

In a currently preferred embodiment, we algorithmically calculate a wind speed based on each of three intercepts: intercept 538a at 20% D, intercept 538b at 25% D, and intercept 538c at 50% D. The three resulting crosswind calculations are compared and any outlier, compared to the other two calculations or compared to the previous crosswind calculation, will be removed. The average of the remaining calculations will be displayed to the user.

Differences in calculations at different intercept distances may also be analyzed to determine headwind or tailwind.

### Analyzing Pixel Array to Find Intercepts

The radius varies along the parabola and can be determined by the parabolic function. The radius R to the vertex V is F(D*0.50). Likewise, the radius at 20% is F(D*0.20) and the radius at 25% is F(D*0.25).

The parabolic model radius is converted to pixels for analysis of the image with the equation radius pixels=2*B*arc tan(−R/D*percentage).

The center 530 point coordinates are converted to pixel coordinates with equations center_x=origin_x+(D*precent*sin(−L)*pixel_scale) and center_y=origin_y+((−D*percent*cos(−L))*sin(M))*pixel_scale).

The circle equation for the radial arc 534 circle_h=origin_x+(D*precent*sin(−L)*pixel_scale) and circle_k as origin_y+((−D*percent*cos(−L))*sin(M))*pixel_scale).

As shown in FIG. 21, the center 530 point is illustrated at a predetermined percentage of the distance from the origin 202 (FIG. 20) and the far point 204 (FIG. 20) along the angular line 540. As the wind blows the string 40 moves along the radial arc 534 at a radius R with the length in pixels as calculated above for the predetermined percentage.

In our field test we used a neon green string. Our novel algorithmic method of determining the crosswind calculates a sequence of radial points 532 along the radial arc 534. First the radial point 532 with radial_x equal to the center_x of the center 530 point is calculated with radial_y equal to center_y plus radius pixels. If the pixel color of the first radial point 532a is neon greenish then the intercept has been found. If not, then we add 1 to the radial_x and calculate the corresponding radial_y=circle_k+squareroot(R²−(radial_x−circle_h)²) for radial point 532b. If the pixel color of the second radial point 532b doesn't match, we move to the left side of the radial arc 534 by subtracting 1 from the center_x for the third radial point 532c. We continue moving one pixel right and then one pixel left, each time calculating the corresponding radial_y, until we find a pixel color that matches the color of the string, e.g. neon green (e.g. radial points 532d, 532e, 532f, 532g, and 532h). As shown in FIG. 21, the intercept 538 is where the current string 40 was visualized at radial point 532h.

This algorithmic method of finding the string intercepts executes much faster than a corresponding DNN method would execute.

In our preferred embodiment, finding a plurality of intercepts (e.g. 538a, 538b, and 538c in FIG. 22) and comparing the resulting calculations eliminates erroneous shape predictor predictions and improves accuracy.

Due to different amounts of ambient light, shadows, and backgrounds, the pixel color of the string 40 will vary from time to time. Accordingly, we developed fuzzy logic to determine when the relative values for red, green, and blue components where within a certain tolerance of each other and of the expected brightness. Further, the comparison of a plurality of intercepts eliminates false detections based on shadows or background influences.

In one embodiment, we adjust the expected brightness based on the predominate color and/or brightness of the sky.

### Known Parameters

As discussed above there are several parameters useful to predicting accurate wind values. These include camera parameters including angular distance scale factor B (e.g. 2855 pixels per radian, width of the sensor (e.g. 4030 pixels, 9.9 mm), focal length (e.g. 24 mm), and pixel scale. These include parabolic model origin 202 (i.e. 0,0), distant D, far point (e.g. D, 0), vertex V (e.g. D/2, vertex_height), parabola A (pA). Additionally, the mapping of the parabola onto the 2D pixel image include pixel image origin 202 (e.g. 270, 695), 3D yaw L is 6.24075 radians and the 3D pitch M is 0.03395 radians, far point (e.g. 1431, 1623), perspective distances along the angular line (e.g. 20% D, 25% D, and 50% D). Other parameters include the target color in red, green, and blue components as well as tolerances for each component.

In some configurations, such as on an archery range, rifle shooting range, elevated hunting stand platform (e.g. in a corn field on private property), the parameters are fixed by the configuration, and parameters can be entered by the user. For example, at an archery range the string might be 40-yard or 80-yard distance D, with a 1-yard vertex height V. The camera is fixed and its parameters such as angular distance scale factor B (e.g. 2855 pixels per radian, width of the sensor (e.g. 4030 pixels, 9.9 mm), focal length (e.g. 24 mm) can be entered by the user. A photo or video can be taken and analyzed to enter accurate image pixel coordinates, such as origin 202 (e.g. 270, 695), 3D yaw L is 6.24075 radians and the 3D pitch M is 0.03395 radians. The correct 3D yaw L and 3D pitch M confirmed visually during system setup to match end of the angular line to the far point. The color of the string can be sampled from the image and target color and tolerances can be set based on images taken under different lighting conditions.

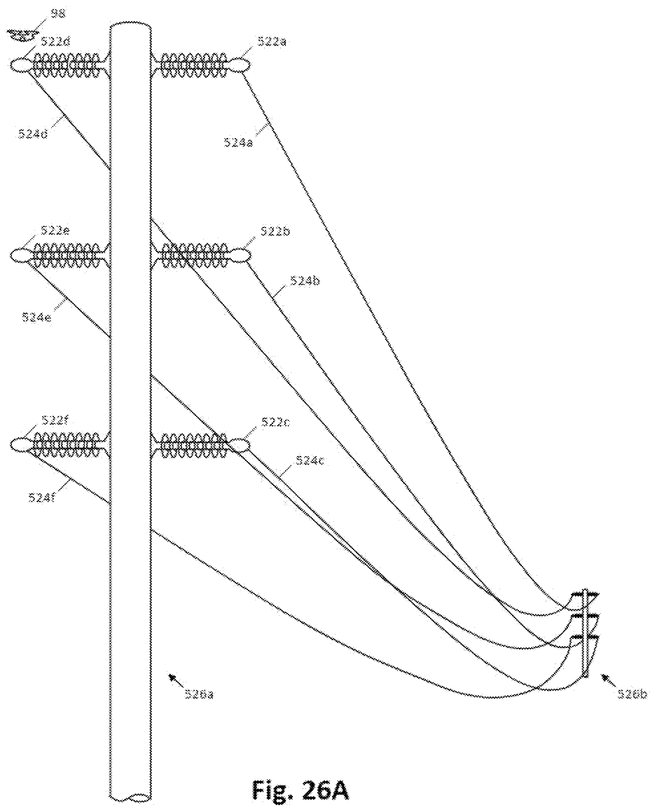

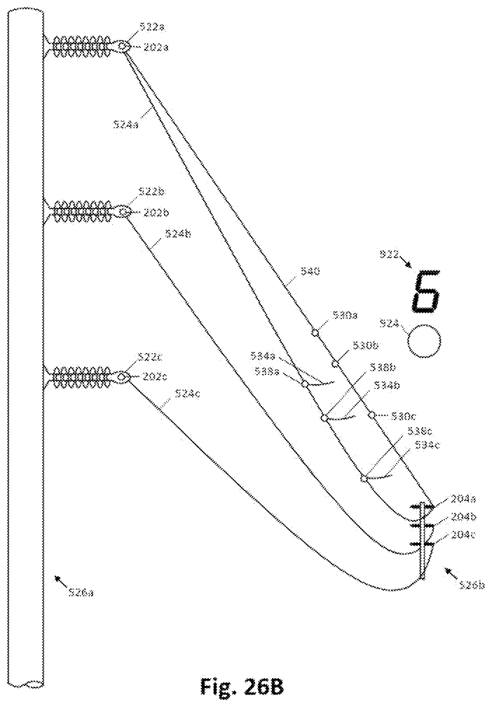

In power line configurations (see FIG. 26A and FIG. 26B) with a fixed camera, the power poles 526 have a predetermined distance D, each power cable 524 has a predetermined vertex V, and known color components. Thus, 3D origin, far point, yaw L, and pitch M can be entered in advance. In power line configurations with a mobile camera, e.g. drone 98 as shown in FIG. 26A, the parameters will be dynamic. In those situations, automated calibration of parameters (as discussed below) is needed.

Not all the parameters need to be entered. For example, if distance 3D origin, yaw L, and pitch M are known, the far point can be calculated. If vertex V and distance D are known the parabolic A pA can be calculated. If camera sensor width and focal length are known, the angular distance scale factor B can be calculated. Entered values can be used to verify calculated values.

### Calibration by AI

The AI device can determine many of the necessary parameters based on object recognition, shape prediction, range detection, or other analysis. In AI calibration embodiments, the AI device 10, detects the origin of the string 40, e.g. by detecting the top of the near rod 106, detects the far point 204 by detecting the 12″×12″ plate 206, and calculates distance D by our range determination method. Once the origin, far point, and distance D are determined, the radius at the vertex V can be determined at 50% D. Once the vertex height is determined the parabolic A pA can be calculated. Points along the string 40 are located in the image based on shape prediction of fiduciary points on the string 40. Color components and tolerances can be determined by comparing the pixel colors of the various predicted fiduciary points on the string. The AI device can confirm or verify the pixel color values by finding intercepts in the image using the method described in relation to FIG. 22.

AI calibration methods will be important in dynamic environments in such as mobile hunting or military situations, where the string configuration, camera position, etc. are not known in advance, or may change.

For example, in situations where a drone 98 is flying along power lines, the AI device may be embedded in the drone 98, and dynamically calibrates the necessary parameters based on a currently captured image or based on an early image once the drone 98 hovers in a position with full view of a parabolic section of the power cable 524.

In other embodiments, the drone 98 is merely transmitting live images to a control center where the AI system displays wind data for a multiplicity of fixed cameras and/or drones.

The AI calibration method may employ slower, more power consuming deep neural networks or multiple detectors and shape predictors. After calibration, the AI device can use algorithmic methods such as discussed in relations to FIG. 22 to rapidly provide realtime wind information while using less computing power and less battery power.

### An Automatic AI Calibration Method for 3D Pitch and 3D Yaw

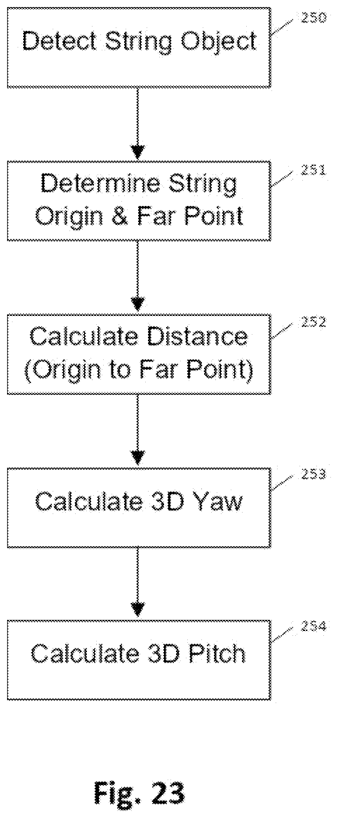

FIG. 23 illustrates the steps in one embodiment of an AI calibration method. In a detect string object 250 step, a string 40 object is detected. In a determine string origin & far point 251 step, a shape predictor provides pixel coordinates for an origin 202 of the string 40 and for the far point 204 of the string. In a calculate distance 252 step the distance between the origin 202 and the far point 204 of the string is calculated. Using the pixel coordinates of the origin 202 and the far point 251, in a calculate 3D yaw 253 step, the 3D yaw L is calculated. Using the pixel coordinates of the origin 202 and the far point 251, in a calculate 3D pitch 254 step, the 3D pitch M is calculated.

### An Algorithmic Method of Calculating Crosswind Based on String Intercepts

When 3D pitch L and 3D yaw M have been provided by an automatic AI calibration method, e.g. as shown in FIG. 23, crosswind values may be calculated using a method of finding string intercepts as illustrated in FIG. 22 and detailed in FIG. 21.

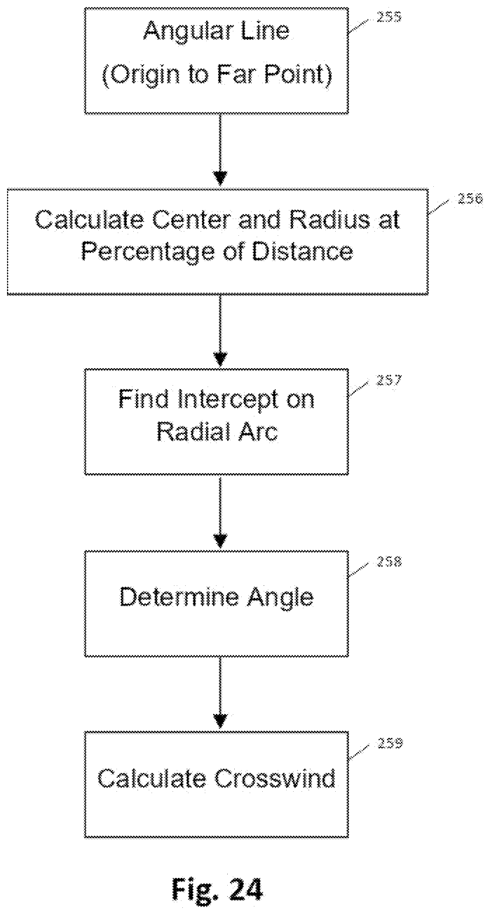

FIG. 24 illustrates the steps in one embodiment of a string intercept method, which executed after the automatic AI calibration as shown in FIG. 23. In angular line 255 step, an angular line 540 is determined, and optionally displayed, from the origin 202 to the end point 204 of the string 40. In a calculate center and radius 256 step, pixel coordinates of a circle center 530 and a corresponding radius R in pixels for a percentage of distance D are calculated. As shown and discussed in reference to FIG. 21, in a find intercept 257 step, the pixel color a sequence of radial points 532 along a radial arc 534 are compared against the expected string color until a match is found. A color match indicates that the actual string was intercepted at an intercept 538 point. In a determine angle 258 step, an angle, at the center 530, between the lowest point in the radial arc 534 and the intercept 538 point is determined. In a calculate crosswind 259 step, the angle is used to calculate a crosswind value. The angle may be used to look up a wind value in a lookup table or may be used in an equation to calculate the value.

In a preferred embodiment, steps 256 through 259 are repeated for a plurality of distances, e.g. 20% D, 25% D, and 50% D. For each image, outliers are removed, and the remaining crosswind values are averaged prior to display to the user.

### Another Algorithmic Method of Calculating Crosswind Based on String Intercepts

When 3D pitch L and 3D yaw M have been provided in fixed configuration by user parameter entry, crosswind values may be calculated using a method of finding string intercepts as illustrated in FIG. 22 and detailed in FIG. 21.

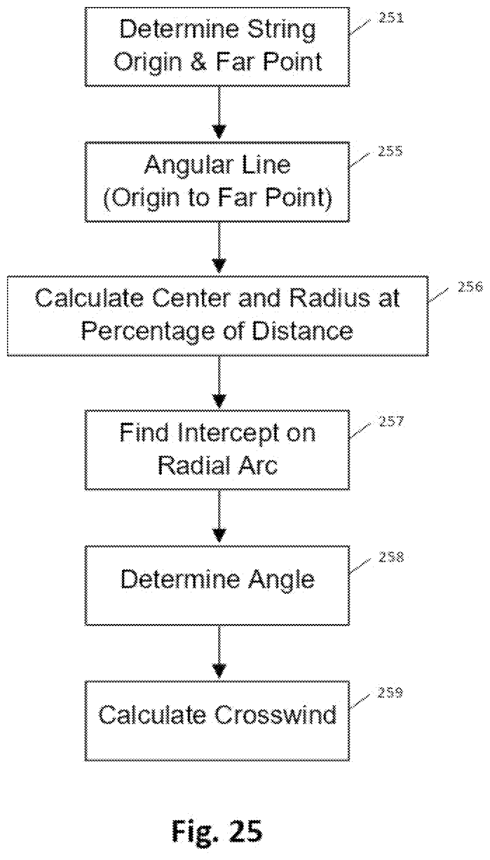

FIG. 25 illustrates the steps in another embodiment of the string intercept method. In a determine string origin & far point 251 step, pixel coordinates for an origin 202 of the string 40 and for the far point 204 of the string is determined by user data entry (or by a shape predictor). In angular line 255 step, an angular line 540 is determined, and optionally displayed, from the origin 202 to the end point 204 of the string 40. In a calculate center and radius 256 step, pixel coordinates of a circle center 530 and a corresponding radius R in pixels for a percentage of distance D are calculated. As shown and discussed in reference to FIG. 21, in a find intercept 257 step, the pixel color a sequence of radial points 532 along a radial arc 534 are compared against the expected string color until a match is found. A color match indicates that the actual string was intercepted at an intercept 538 point. In a determine angle 258 step, an angle, at the center 530, between the lowest point in the radial arc 534 and the intercept 538 point is calculated. In a calculate crosswind 259 step, the angle is used to calculate a crosswind value.

### Determining Cross Wind Effects on Power Cables on Power Poles

Determine cross wind effects on electrical fire distribution lines is important to prevent wildfires.

FIG. 26A illustrates a drone 98 flying along high voltage electricity distribution power lines. The drone 98 may act as a camera for the AI system of this invention or may have the AI device embedded in the drone 98.

FIG. 26A shows a near power pole 526a (analogous to near rod 106 in FIG. 20) and a far power pole 526b. As shown, six power cables 524a-f are attached to the near power pole 526 at each of six insulators 522a-f, respectively. Likewise, the far ends of each power cable 524a-f are attached to the insulators 522 on the far power pole 526b. Each power cable 524 is analogous to a string 40 in FIG. 20.

FIG. 26B shows a high-resolution display 31 of an AI system. The image shows the near power pole 526a and the far power pole 526b (from FIG. 26A). For simplicity only three power cables 524a-c (i.e. the right side of the power line shown in FIG. 26A) are shown being analyzed by the AI device 10. Analogous to the descriptions above regarding FIG. 21 and FIG. 22, FIG. 26B shows three origins 202a-c for the power cables 524a-c and three far points 204a-c. The end of the insulator 522a-c maybe used to identify the respective origins 202a-c. Because insulators 522 have standard shapes and sizes and components, the insulators 522 can be used for range detection. Each of the power cables 524a-c for a parabolic curve which for which a parabolic model is developed. Due to the precision of power line construction, the distance D for each of the three power cables 524a-c will be almost equivalent. We have observed that the vertex V height for different cables may be different such that the parabola A pA constant may be slightly different for each of the three power cables 524a-c.

In preferred embodiments, at least three, or all six, power cables 525a-f are analyzed for cross wind speed, and the results are compared to remove outliers and to provide the most accurate wind information.

However, for simplicity, only the first cable 524a is shown with annotations in FIG. 26B. Analogous to the display of FIG. 22, the AI device 10 calculates and optionally displays an angular line 540 between the origin 202a and the far point 204a. In this example, the far point 204a is 159 yards away from the origin 202a. The range or distance D is 159 yards. The angular line 540 is the x-axis for a parabolic model, where the origin 202 is at x,y coordinates 0,0 and the far point 204 is at x,y coordinates 159,0. The AI device can measure the distance between midway point on the angular line 540 and the vertex V (e.g. 538c) to determine the height H of the parabola. In this example H is −3 yards. The parabola A (pA) constant is calculated as pA=−H/(D/2)². The parabolic function of x, F(x)=pA*x*(x−D), which will give the y value for any point along the parabola (as indicated by the x value).

For analysis of the image of the power cable 524a in FIG. 26B, the 2D model of the parabola is mapped to the 2D pixels coordinates of the image.

The origin 202 is identified in pixel coordinates in the image. Variables origin_x and origin_y are used to apply the origin location. The AI device 10 optionally draws a circular dot on the display 31 centered at origin_x, origin_y.

The far point 204 is identified in pixel coordinates in the image. Variables far_x and far_y are used to apply the far location. The AI device 10 optionally draws a circular dot on the display 31 centered at far_x, far_y.

The AI device 10 optionally draws the angular line 540 on the display 31 from points (origin_x, origin_y) to (far_x, far_y).

The camera is positioned with a certain perspective in relationship to the string 40. In order to correlate the pixel coordinates of the 2D image with the x,y coordinates of the parabolic model, the 3D yaw L and the 3D pitch M of the camera perspective must be determined. For example, the 3D yaw L and the 3D pitch M can be visualized in FIG. 26B by observing the origin 202a and the angular line 540. The angular line 540 is yawed to the right and is pitched down.

The pixel coordinates for the far point 204 may be calculated as far_x=origin_x+(D*sin(−L)*pixel_scale) and far_y=origin_y+((−D*cos(−L))*sin(M))*pixel_scale). The pixel scale for the drone 98 (FIG. 26A) will be a known value.

When the wind blows, power cable 524a will generally maintain its parabolic shape and any point on the power cable 524a will rotate in a circular radial arc 534. For example, the vertex V will rotate around a center 530c point on the angular line 540 along radial arc 534c. The radial arc 534 is in a plane perpendicular to the plane of the parabola in the 2D parabolic model. The current position of the power cable 524a will intersect the calculated radial arc 534c at an intercept 538c.

In some embodiments, the crosswind calculation is a function of an angle between a line from the center 530 point on the angular line 540 and the corresponding intercept 538 point determined by algorithmically as discussed above regarding FIG. 21 and a line from the center 530 point on the angular line 540 and the minimum point on the radial arc 534. For example, in FIG. 26B, the intercept 538c of the center 530c point is angled to the right of minimum of the corresponding radial arc 534c, indicating a 6-m.p.h. crosswind as shown in the crosswind indicator 922 (from the left).

The AI device 10 determines the steady state of wind and displays indicators of a steady state of wind, namely the green indicator 924 (shown), yellow indicator 926, and red indicator 928, as discussed above.

Due to the perspective captured by a camera in a digital image 36, the points along the power cable 524a closer to the camera have greater precision (i.e. more pixels) in the range of movement along the radial arc 534. We found good results by selecting three distances along the angular line 540, i.e. 20% of the distance D, 25% D, and 50% D, shown in FIG. 26B as center 530a, 530b, and 530c, which are the centers for calculating the radial arcs 534a, 534b, and 534c, respectively.

In a currently preferred embodiment, we algorithmically calculate a wind speed based on each of three intercepts: intercept 538a at 20% D, intercept 538b at 25% D, and intercept 538c at 50% D. The three resulting crosswind calculations are compared, an any outlier compared to the other two calculations or compared to the previous crosswind calculation will be removed. The average of the remaining calculations will be displayed to the user.

The radius varies along the parabola and can be determined by the parabolic function. The radius R to the vertex V is F(D*0.50). Likewise, the radius at 20% is F(D*0.20) and the radius at 25% is F(D*0.25).

The parabolic model radius is converted to pixels for analysis of the image with the equation radius pixels=2*B*arc tan(−R/D*percentage).

The center 530 point coordinates are converted to pixel coordinates with equations center_x=origin_x+(D*precent*sin(−L)*pixel_scale) and center_y=origin_y+((−D*percent*cos(−L))*sin(M))*pixel_scale).

The circle equation for the radial arc 534 circle_h=origin_x+(D*precent*sin(−L)*pixel_scale) and circle_k as origin_y+((−D*percent*cos(−L))*sin(M))*pixel_scale).

Intercepts 538a-c are each found as described above in relation to FIG. 21.

The power cable intercept 538 point pixel color value may be a dark shade of gray against a sky background or may appear to be bright silver with the sunlight hitting from above.

This algorithmic method of finding the string intercepts executes much faster than a corresponding DNN method would execute.

In our preferred embodiment, finding a plurality of intercepts (e.g. 538a, 538b, and 538c in FIG. 26B) and comparing the resulting calculations eliminates erroneous detections and improves accuracy.

Due to different amounts of ambient light, shadows, backgrounds, and sun direction, the pixel color of the power cables 524 will vary from time to time. Accordingly, we developed fuzzy logic to determine if the when the relative values for red, green, and blue components where within a certain tolerance of each other and of the expected brightness. Further, the comparison of a plurality of intercepts eliminates false detections based on light differences.

We also observed that metal power cable 524 are heavier and have more inertia than light-weight string 40. For example, the same crosswind will deflect a light-weight string 40 at a greater angle than a power cable with the same configuration. Three metal power cable 524a-c (e.g. see FIG. 26B) may oscillate out of sync during the same wind gusts. The power cable 524 with the greatest angle is the best indication of the speed of current wind gust.

### Minimizing Power Outages and Wildfires

Weather forecasting has advanced to a degree that high wind events can be predicted days and even weeks in advance. Regional wind maps can show areas where wind will exceed 50 m.p.h. Power distribution companies, such as Pacific Gas and Electric or Southern California Edison, can use embodiments of this invention to fly drones 98 or obtain images from pole mounted cameras during predicted higher wind periods to determine if any tree branches are close to contacting power cables. Those companies can use this invention to inspect power lines on a regular basis and to cost efficiently schedule tree work to prevent wildfires.

Similarly, when a high wind event is forecast power distribution companies can identify in advance which sections of power lines are likely to be shut off and can deploy drones to observe the effects of crosswinds on critical sections in real time and to make the decision to shut off power, or the decision to restore power, in realtime with great accuracy, whereby only necessary shut offs are executed and the period of the power shutoff is minimized.

### Lightweight, Low Power Handheld AI Devices

For hunting and foot mobile power line inspection and warfighting environments, having a lightweight, low power consuming handheld AI device provides several benefits of ease of transporting and ease of use in the field.

In some embodiments, the handheld AI device can be implemented having an optical path and a reflected segment display e.g. LCD or OLED, similar to current products, such as Leupold RX-FullDraw 5 and RX-1400i True Ballistic Range/Wind (TBR/W) Gen 2, wherein the current laser range sensor is replaced with laser-less, no emission range sensor, such as an image analysis range determining method. Battery power no longer needed for the laser and the ranging finding sensor could be applied to the image analysis. The wind information would be displayed using segments, e.g., as shown in FIGS. 15A through 15C.

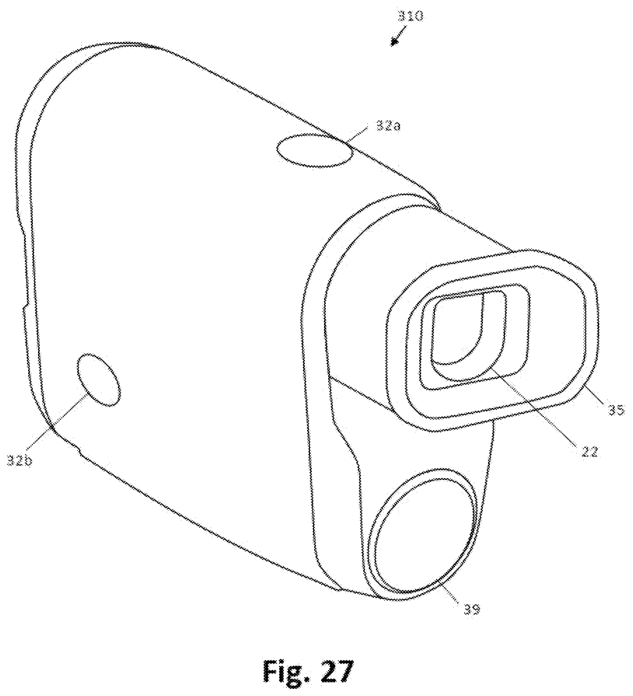

In another embodiment, FIG. 27 illustrates a high-resolution AI device 310 having a high-resolution digital display 31 (internal) viewed through an eyepiece 22. In both hunting and foot mobile warfighting environments, it is important that the high-resolution AI device 310 does not light up the face or body of the user. In this preferred embodiment, the eyepiece 22 is shielded against stray light by a visor or shroud 35. The shroud 35 also is a barrier for comfort, improving image contrast by blocking peripheral light from entering the eye and acts as a barrier for moisture, dust, and maintaining proper eye relief for better focus. The high-resolution AI device 310 is shown with a battery compartment 39 which could receive either conventional or rechargeable batteries. The high-resolution AI device 310 also comprises inputs 32, shown with an operation button 32a and a mode button 32b.

### Deep Convolutional Neural Network

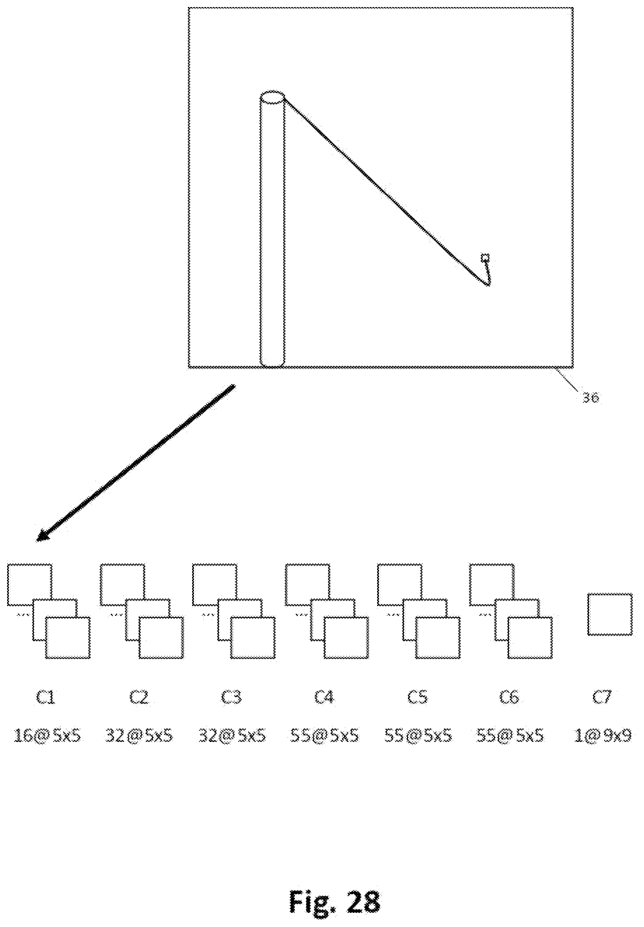

FIG. 28 illustrates a deep convolutional neural network for detecting wind speed and direction using an image 36 of a string.

Deep CNNs are described in papers including Gradient-based learning applied to document recognition by LeCun, Yann, et al. and Max-Margin Object Detection by Davis E. King. Source code for a vehicle detector using max-margin object detection is available as part of the dlib library at https://dlib.net/ml.html#loss_mmod_.

FIG. 28 shows an image 36 of a string attached to a rod and a plate.

The first convolutional layer C1 of the deep CNN illustrated in FIG. 28 receives the image 36 as input. Convolutional layer 1 C1 has 16 feature maps, each with a size of 5×5 (notated as 16@5×5). Each feature map is fed into the next layer as a channel. Convolutional layer 2 C2 and convolutional layer 3 C3 each have 32 feature maps, each with a size of 5×5 (notated as 32@5×5). Convolutional layer 4 C4, convolutional layer 5 C5, and convolutional layer 6 C6 each have 55 feature maps, each with a size of 5×5 (notated as 55@5×5). The final convolutional layer 7 C7 has one feature map with a size of 9×9. ReLU is applied to each layer except the final convolutional layer 7 C7.

### Advantages

### Accurate

The AI device provides for accurate adjustment of aim for a given wind condition. More accurate cross wind information provides for better decision-making regarding shutting down of power lines during a wind event.

### Effective

Because the AI device provides for accurate adjustment of aim for a given wind condition, each shot taken will be more effective.

### Confidence

The AI wind information gives the user confidence that despite difficult wind conditions a shot can be successfully taken. This increased confidence will improve the user's performance and satisfaction.

Power distribution companies can make decisions to trim trees and to shut down power with greater confidence, resulting in greater efficiency and power customer satisfaction.

### Increased Safety

More accurate aiming increases safety. More accurate and more specific wind impact on power lines and nearby trees provides safer operation of power distribution systems and reduces wildfires. Even in strong wind a user is assured that any object that may be impacted by the projectile will not be unknowingly harmed.

### Adjustable

The embodiments of these AI device displays are adjustable to be consistent with an individual user associated sights, for example, distances could be presented in yards or meters. Parameters for wind models can be adjusted based on known values, such as distances between power poles.

Drones can be dispatched based on wind predictions or areas of concern.

### Lightweight

Handheld or portable mounted AI devices are lightweight.

### Easy to Transport and Use

AI devices are easy to transport and use.

### Rapid Use

Embodiments that provide an aiming point are used rapidly without having to use brain power to select numbers and estimate an aiming point.

Drones can provide real time crosswind values.

### Conclusion, Ramification, and Scope

Accordingly, the reader will see that the novel AI device provides important information regarding the projectile trajectory path, or wind along power lines, and importantly provides greater accuracy, effectiveness, and safety.

While the above descriptions contain several specifics these should not be construed as limitations on the scope of the invention, but rather as examples of some of the preferred embodiments thereof. Many other variations are possible. For example, the training object could be other objects along the projectile trajectory path, such as grass or trees. Further, the AI device and methods could be applied to military situations where the projectiles are fired from a cannon, tank, ship, or aircraft and where the targets could be moving objects such as helicopters or warfighters. Additionally, the AI device and methods could be applied to golf where in a golf mode the device would indicate crosswind corrected aiming point and which golf club would result in a ball trajectory that place the ball nearest the desired hole. The variations could be used without departing from the scope and spirit of the novel features of the present invention.

Accordingly, the scope of the invention should be determined not by the illustrated embodiments, but by the appended claims and their legal equivalents.

1. A system for recognizing wind effects on an object from an origin point to a far point, the system comprising:
a) a computing element,
b) a memory connected to the computing element,
c) a machine learning model implemented in the computing element and the memory,
d) a display connected to the computing element,
e) at least one image sensor, and
f) at least one lens with a known magnification, in the optical path of the image sensor,
wherein the image sensor captures a digital image having the known magnification,
wherein the digital image is transferred to the memory and analyzed by the computing element,
wherein the computing element recognizes the object in the magnified digital image,
wherein the computing element determines a plurality of fiduciary points on the object,
wherein the computing element determines the wind effects on the object, and
wherein a crosswind valve of the wind effects is shown on the display.

2. The system of claim 1,
wherein the machine learning model identifies the origin point and the far point and the distance between the origin point and the far point.

3. The system of claim 1,
wherein the machine learning model comprises an algorithmic model.

4. The system of claim 1,
wherein machine learning model comprises a deep neural network,
wherein the crosswind value is a classification output of the deep neural network.

5. The system of claim 1, further comprising wireless communication,
wherein the digital image is transmitted via the wireless communication.

6. The system of claim 5,
wherein the image sensor and the lens are configured in a fixed location,
wherein the computing element, the memory, and the display are configured in a second location,
whereby the crosswind valve is displayed at a location remote from the fixed location.

7. The system of claim 5,
wherein the image sensor and the lens are configured in a drone,
wherein the computing element, the memory, and the display are configured in a location separate from the drone,
whereby the crosswind valve is displayed at a location remote from the drone.

8. A handheld device comprising:
a) a housing enclosing the system of claim 1,
b) an eyepiece connected to the housing for viewing the display,
c) a shroud around the eyepiece, whereby the eyepiece is shielded,
d) at least one input button for activating the recognition of wind effects on the object, and
e) a battery compartment for receiving a battery,
whereby the device is used in the field to determine and display the crosswind valve.

9. The handheld device of claim 8, further comprising:
a) a crosshair shown in the display, wherein a target object is selected when the input button is pressed,
b) an aiming point,
wherein the computing element determines a range to the target object,
wherein the computing element determines the wind effects along at least a portion of the projectile trajectory path to the target,
wherein the aiming point is displayed based on the range to the target and the crosswind valve,
whereby the handheld device is used in the field to determine and display the aiming point adjusted for the range to the target and the wind effects along the projectile trajectory path.

10. The system of claim 1,
wherein the object is a string,
wherein the string forms a parabolic curve having a vertex,
wherein the machine learning model determines a deflection angle of the string, and
wherein the crosswind valve is determined based on the deflection angle of the string.

11. The system of claim 1,
wherein the object is a power cable,
wherein the origin is a connection to a near insulator on near power pole and the far end is a connection to a far insulator on a far power pole,
wherein the power cable forms a parabolic curve having a vertex,
wherein the machine learning model determines a deflection angle of the power cable, and
wherein the crosswind valve is determined based on the deflection angle of the power cable,
whereby wildfires are reduced, or
whereby wind related power shut offs are minimized.

12. A method of determining the crosswind valve executing on the system of claim 1, using parameters comprising:
a) pixel coordinates of the origin point in the image,
b) distance from the origin point to the far point,
c) 3D yaw of an angular line from the origin point to the far point,
d) 3D pitch of the angular line, and
e) vertex height of a parabola formed by the object,
wherein the computing element determines a center point on the angular line above vertex and a radius length at the vertex,
wherein the computing element determines an angle at the center point between the vertex and a current fiduciary point on the wind deflected object, and
wherein the computing elements determines current valve of the crosswind value based on the angle.

13. The method of claim 12, wherein at least one of the parameters is automatically determined by analyzing the image during calibration.

14. The automatic calibration of claim 13, comprising the steps of:
a) detecting the object,
b) determining the pixel coordinates of the origin point and the far point,
c) calculating the distance between the origin point and the far point,
d) calculating the 3D yaw, and
e) calculating the 3D pitch.

15. The method of claim 12, wherein at least one of the parameters is determined by a fixed configuration and is entered by the user.

16. A fast intercept finding method of finding the current fiduciary point on the wind deflected object of the method of claim 12, the fast intercept method finding method comprising the steps of:
a) calculating the angular line in image pixel coordinates,
b) calculating the center point on the angular line in image pixel coordinates and the radius pixel length at a predetermined percentage of the distance from the origin point to the far point,
c) finding an intercept point on a radial arc with the current wind deflected object,
d) determining the angle at the center point between the no wind intercept and the current fiduciary point on the wind deflected object, which is the found intercept point, and
e) calculating the crosswind value,
whereby the crosswind valve is determined in real time.

17. The fast intercept finding method of claim 16,
wherein the finding the intercept including matching the color components of an image pixel on the radial arc with expected color components and tolerances.

18. The fast intercept finding method of claim 16,
wherein a plurality of crosswind values is calculated at different percentages of the distance,
wherein outlier crosswind values are ignored, and
wherein the displayed crosswind valve is an average of the plurality of valid crosswind values,
whereby the crosswind valve is more accurate.

19. The system of claim 10,
wherein the string is attached to a plate of known height at the far end, and
wherein the computing element determines the distance to the plate based on the pixel height of the plate.

20. The system of claim 1,
wherein the computing determines a wind speed which is sustained for a period of time and indicates when the sustained wind speed is present.
